(19) United States
(12) Patent Application Publication
(10) Pub. No.: US 2026/0143427 A1
(43) Pub. Date: May 21, 2026

(54) ENHANCED RADIO ACCESS NETWORK SYSTEMS AND METHODS FOR BEAM-BASED LOW-POWER WAKE-UP SIGNAL TRANSMISSION IN WIRELESS COMMUNICATIONS

(71) Applicant: INTEL CORPORATION, Santa Clara, CA (US)

(72) Inventors: Yingyang LI, Beijing (CN); Yi WANG, Beijing (CN); Gang XIONG, Portland, OR (US); Debdeep CHATTERJEE, San Jose, CA (US); Toufiqul ISLAM, Milpitas, CA (US); Daewon LEE, Portland, OR (US)

(73) Assignee: INTEL CORPORATION, Santa Clara, CA (US)

(21) Appl. No.: 19/119,705

(22) PCT Filed: Oct. 30, 2023
(86) PCT No.: PCT/US2023/078168

§ 371 Date: Apr. 9, 2025

Related U.S. Application Data
(60) Provisional application No. 63/422,701, filed on Nov. 4, 2022.
(60) Provisional application No. 63/484,953, filed on Feb. 14, 2023.

(51) Int. Cl. H04W 52/02; H04W 68/02

(52) U.S. Cl. CPC H04W 52/0235; H04W 68/02

(57) ABSTRACT

This disclosure describes systems, methods, and devices for low-power wake-up signaling. A user equipment (UE) device may detect, by a low-power wake-up receiver of the UE device, a first low-power wake-up signal; detect, by the low-power wake-up receiver, a second low-power wake-up signal; and signal, by the low-power wake-up receiver, based on the second low-power wake-up signal, to the main receiver, that the main receiver is to wake up from a sleep state.

### CROSS-REFERENCE TO RELATED PATENT APPLICATION(S)

This application claims the benefit of U.S. Provisional Application No. 63/422,701, filed Nov. 4, 2022, and U.S. Provisional Application No. 63/484,953, filed Feb. 14, 2023, the disclosures of which are incorporated herein by reference as if set forth in full.

### TECHNICAL FIELD

This disclosure generally relates to systems and methods for wireless communications and, more particularly, to beam-based low-power wake-up signal transmission.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example network environment, in accordance with one or more example embodiments of the present disclosure.

FIG. 2 illustrates example processes for controlling a main receiver with a low-power wake-up receiver, in accordance with one or more example embodiments of the present disclosure.

FIG. 3A illustrates an example of up to four low-power wake-up signals (LP-WUSs) in a half-frame with subcarrier spacing of 15 kHz, in accordance with one or more example embodiments of the present disclosure.

FIG. 3B illustrates an example of up to four LP-WUSs in a half-frame with subcarrier spacing of 30 kHz, in accordance with one or more example embodiments of the present disclosure.

FIG. 4A illustrates an example of up to eight LP-WUSs in a half-frame with subcarrier spacing of 15 kHz, in accordance with one or more example embodiments of the present disclosure.

FIG. 4B illustrates an example of up to eight LP-WUSs in a half-frame with subcarrier spacing of 30 kHz, in accordance with one or more example embodiments of the present disclosure.

FIG. 5A illustrates an example of up to eight LP-WUSs in a frame with subcarrier spacing of 15 kHz, in accordance with one or more example embodiments of the present disclosure.

FIG. 5B illustrates an example of up to eight LP-WUSs in a frame with subcarrier spacing of 15 kHz, in accordance with one or more example embodiments of the present disclosure.

FIG. 5C illustrates an example of up to eight LP-WUSs in a frame with subcarrier spacing of 30 kHz, in accordance with one or more example embodiments of the present disclosure.

FIG. 6A illustrates an example of a LP-WUS burst with subcarrier spacing of 15 kHz, in accordance with one or more example embodiments of the present disclosure.

FIG. 6B illustrates an example of a LP-WUS burst with subcarrier spacing of 15 kHz, in accordance with one or more example embodiments of the present disclosure.

FIG. 7 illustrates an example of duty-cycle-based LP-WUS detection, in accordance with one or more example embodiments of the present disclosure.

FIG. 8 illustrates an example LP-WUS associated with a paging frame and paging occasion for a paging operation, in accordance with one or more example embodiments of the present disclosure.

FIG. 9 illustrates an example LP-WUS associated with a paging frame and paging occasion for a paging operation, in accordance with one or more example embodiments of the present disclosure.

FIG. 10 illustrates a flow diagram of illustrative process for beam-based LP-WUS, in accordance with one or more example embodiments of the present disclosure.

FIG. 11. illustrates a network, in accordance with one or more example embodiments of the present disclosure.

FIG. 12 schematically illustrates a wireless network, in accordance with one or more example embodiments of the present disclosure.

FIG. 13 is a block diagram illustrating components, in accordance with one or more example embodiments of the present disclosure.

FIG. 14 illustrates a network, in accordance with one or more example embodiments of the present disclosure.

FIG. 15 illustrates a simplified block diagram of artificial (AI)-assisted communication between a user equipment and a radio access network, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3^{rd} Generation Partnership Program (3GPP) define communication techniques, including for low-power, power-save modes that allow a device to enter a low-power state (e.g., sleep mode) for a time period, and wake up upon receiving a wake-up signal (WUS) transmission. A UE may detect a WUS before having to monitor a PDCCH, so the UE may save power by not having to monitory the PDCCH until the UE receives the WUS. 3GPP DRX operations allow the UE to wakeup periodically to monitor the PDCCH, and a DRX operation with a WUS allows the UE to remain in sleep mode until it receives the WUS, at which time the UE may monitor the PDCCH.

5G (5^{th} Generation) systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Designs to prolong battery life is a necessity for improving energy efficiency as well as for better user experience.

The power consumption depends on the configured length of wake-up periods, e.g., paging cycle. To meet the battery life requirements above, a long DRX cycle is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, long DRX cycle cannot meet the delay requirements. Therefore, it is necessary to reduce the power consumption with a reasonable latency.

Currently, UEs need to periodically wake up once per DRX cycle, which dominates the power consumption in periods with no signaling or data traffic. If UEs are able to wake up only when they are triggered, e.g., paging, power consumption could be dramatically reduced. This can be achieved by using a wake-up signal to trigger the main radio and a separate receiver which has the ability to monitor wake-up signal with ultra-low power consumption. The UE's main receiver works for data transmission and reception, which can be turned off or set to deep sleep unless it is turned on. In the power saving state, if no wake-up signal is received by the wake-up receiver, the main receiver stays in OFF state for deep sleep. On the other hand, if a wake-up signal is received by the wake-up receiver, the wake-up receiver will trigger to turn on the main receiver. In the latter case, because the main receiver is active, the wake-up receiver can be turned off.

The power consumption for monitoring wake-up signal depends on the wake-up signal design and the hardware module of the wake-up receiver used for signal detecting and processing. In the present disclosure, some basic designs for beam-based low-power wake-up signal transmission are provided.

In one or more embodiments, the low-power wake-up signal (LP-WUS) can be transmitted by gNB to indicate whether a UE needs to wake-up for transmission under the main radio. If a LP-WUS is detected by a UE, the UE can turn on the main receiver for control/data reception. Otherwise, the UE may not turn on the main receiver for power saving. A LP-WUS may consist of two parts. A first part may carry a sequence to help the LP-WUS receiver to prepare for the detection of the second part which carries the payload of wake-up information. Alternatively, a LP-WUS may only consist of one part. For example, the LP-WUS may be generated based on a sequence. Alternatively, channel coding can be applied to encode the payload that is transmitted on the LP-WUS. Multiple types of LP-WUS can be defined. A first type of LP-WUS may be mainly used as reference for time/frequency synchronization and/or measurement, e.g., RRM, which may be referred as LP-synchronization signal (LP-SS). The first type of LP-WUS may be transmitted periodically. Then, a second type of LP-WUS can serves as indicator for wake-up. The second type of LP-WUS may also provide the function for synchronization and/or measurement.

In one or more embodiments, the downlink transmission in NR could be beam-based. For example, for the carrier frequency in frequency range 1 (FR1), up to 4 or 8 beams for SSBs can be transmitted; for the carrier frequency in frequency range 2 (FR2), up to 64 beams for SSBs can be transmitted. Correspondingly, LP-WUS from gNB is likely to use beam-based transmission.

In one or more embodiments, for a cell with N beams for SSB transmission, M beams for LP-WUS transmission can be used. Note: N and M in the above statement is the maximum number of beams for SSBs and LP-WUSs. It is up to gNB to only transmit a smaller number of SSBs and LP-WUSs. M may equal to N, which allows to use the same beam pattern for SSB and associated LP-WUS. M may be larger than N. By this way, the beam for LP-WUS can be narrower than SSB which allows larger beamforming gain for better coverage. M may be smaller than N too. The above N beams of SSBs are transmitted in a half-frame, which are named as a SSB burst. Correspondingly, the M beams for LP-WUS are referred to as a LP-WUS burst in the present disclosure.

One or more of the following rules can be considered to define the mapping pattern for the M LP-WUS in the LP-WUS burst. (1) The first n OFDM symbols in a slot may not be used for LP-WUS. By this way, it allows better flexibility to transmit a control channel resource set (CORESET) and a LP-WUS in a slot, especially when the CORESET and the LP-WUS may use different beams. (2) The last m OFDM symbols in a slot may not be used for LP-WUS. By this way, it allows better flexibility to multiplex a physical uplink control channel (PUCCH) and a LP-WUS in a slot. (3) A LP-WUS can be mapped to OFDM symbols in one or more slots. A LP-WUS can occupy consecutive OFDM symbols across multiple slots. Alternatively, A LP-WUS can occupy consecutive OFDM symbols in a slot. Note: The number of occupied OFDM symbols of a LP-WUS can be determined by other factors, e.g., the payload size carried by the LP-WUS. (4) Two LP-WUSs may not occupy adjacent OFDM symbols.

In one or more embodiments, a LP-WUS burst may be limited to a burst of the first type of LP-WUS, or a burst of the second type of LP-WUS. Alternatively, a LP-WUS burst may refer to any type from the two types of LP-WUS.

LP-WUS Burst Associated with a SSB Burst:

The LP-WUSs in a LP-WUS burst may be respectively associated with the SSBs in a SSB burst.

In one or more embodiments, a LP-WUS burst may be defined within a half-frame. A LP-WUS burst may be configured in the same half-frame as a SSB burst. In this case, if a LP-WUS may be overlapped in time with a SSB, the beam of the LP-WUS needs to be aligned with the beam of the SSB. Alternatively, a LP-WUS burst may be configured in the different half-frames from a SSB burst. In one option, one LP-WUS can be defined within a subframe and up to 4 LP-WUSs in a LP-WUS burst can be transmitted in a half-frame. One example for the LP-WUS burst is in a half-frame with subcarrier spacing (SCS) of 15 kHz. Each of the first 4 slots in a half-frame can contain a LP-WUS. A LP-WUS may occupy OFDM symbol index 2 to 11 in a slot. Another example for the LP-WUS burst is in a half-frame with SCS 30 kHz. Each of the first 4 subframes in a half-frame can contain a LP-WUS. A LP-WUS may occupy OFDM symbol index 2 to 13 in a first slot and index 0-11 in a second slot in a subframe. In another option, two LP-WUSs can be defined within a subframe and up to 8 LP-WUSs in a LP-WUS burst can be transmitted in a half-frame. One example for the LP-WUS burst is in a half-frame with SCS 15 kHz. Each of the first 4 slots in a half-frame can contain two LP-WUSs. The two LP-WUSs may respectively occupy OFDM symbol index 2 to 5 and index 8 to 11. In one example for the LP-WUS burst in a half-frame with SCS 30 kHz, each of the first 4 subframes in a half-frame can contain two LP-WUSs. In a subframe, a first LP-WUS may be mapped to OFDM symbol index 2 to 12 in a first slot, and a second LP-WUS may be mapped to OFDM symbol index 1 to 11 in a second slot.

In one or more embodiments, a LP-WUS burst may be defined within a period 10×k ms. k can be a predefined value or a configured value by high layer signaling. For example, k=1. Note: The LP-WUSs in a LP-WUS burst in 10×k ms may be respectively associated with the SSBs in a SSB burst in a half-frame. A LP-WUS burst may be configured in a period 10×k ms which contains the half-frame of a SSB burst. Alternatively, a LP-WUS burst may be configured in a period 10×k ms which doesn't contain the half-frame of a SSB burst. In one option, a LP-WUS can be defined within a subframe and up to 8 LP-WUSs in a LP-WUS burst can be transmitted in a frame. In one example for the LP-WUS burst in a frame with SCS 15 kHz, each of the first 8 subframes in a frame can contain a LP-WUS. A LP-WUS may occupy OFDM symbol index 2 to 11 in a slot. In one example for the LP-WUS burst in a frame with SCS 15 kHz, each of the first 8 subframes in a frame can contain a LP-WUS. A LP-WUS may occupy OFDM symbol index 2 to 11 in a slot. In one example for the LP-WUS burst in a frame with SCS 30 kHz, each of the subframe 0-3 and 5-8 in a frame can contain a LP-WUS. A LP-WUS may occupy OFDM symbol index 2 to 13 in a first slot and index 0-11 in a second slot in a subframe.

LP-WUS Burst Associated with Type0 CSS Set of a SSB Burst:

In one or more embodiments, the LP-WUSs in a LP-WUS burst may be respectively associated with the Type0 CSS set which are associated with the SSBs in a SSB burst. Note: for each SSB in a SSB burst, two timings for Type0 CSS set can be determined, e.g., in slot n0 and n0+1. In a LP-WUS burst, there can be only one timing for a LP-WUS associated with a Type0 CSS set. In this case, a LP-WUS may be always mapped to the first timing of the two timings of the Type0 CSS set for a SSB. Alternatively, a LP-WUS may be always mapped to the second timing of the two timings of the Type0 CSS set for a SSB. Alternatively, in a LP-WUS burst, there are also two LP-WUSs which are associated with the two timing of Type0 CSS set.

In 3GPP TS 38.213 of NR (new radio), for the SS/PBCH block and CORESET multiplexing pattern 1, a UE monitors PDCCH in the Type0-PDCCH CSS set over two slots. For SS/PBCH block with index i, the UE determines an index of slot n₀ as

$${n}_{0} = ( O \cdot {2}^{μ} + ⌊ i \cdot M ⌋ ) mod {N}_{slot}^{frame , μ}$$

that is a frame with system frame number (SFN) SFN_{C} satisfying

$${SFN}_{C} mod 2 = 0 if ⌊ ( O \cdot {2}^{μ} + ⌊ i \cdot M ⌋ ) / {N}_{slot}^{frame , μ} ⌋ mod 2 = 0 ,$$

or in a frame with SFN satisfying

$${SFN}_{C} mod 2 = 1 if ⌊ ( O \cdot {2}^{μ} + ⌊ i \cdot M ⌋ ) / {N}_{slot}^{frame , μ} ⌋ mod 2 = 1$$

where μ∈{0, 1, 2, 3, 5, 6} based on the SCS for PDCCH receptions in the CORESET (e.g., according to TS 38.211).

For μ∈{0, 1, 2, 3} and for a SS/PBCH block index i, the two slots including the associated Type0-PDCCH monitoring occasions are slots n₀ and n₀+1. M, 0, and the index of the first symbol of the CORESET in slots n₀ and n₀+1 are provided by Table 13-11 and Table 13-12 of TS 38.211. For μ=5 and for a SS/PBCH block index i, the two slots including the associated Type0-PDCCH monitoring occasions are slots n₀ and n₀+4. M, 0, and the index of the first symbol of the CORESET in slots n₀ and n₀+4 are provided by Table 13-12A of TS 38.211, where X=1.25. For μ=6 and for a SS/PBCH block index i, the two slots including the associated Type0-PDCCH monitoring occasions are slots n₀ and n₀+8. M, 0, and the index of the first symbol of the CORESET in slots n₀ and n₀+8 are provided by Table 13-12A of TS 38.211, where X=0.625.

In one or more embodiments, a LP-WUS burst may be defined within a period of 20 ms which is same as the periodicity of Type0 CSS set. The period of 20 ms may include an even frame followed by an odd frame. The LP-WUSs in a LP-WUS burst in a period of 20 ms may be respectively associated with the Type0 CSS set in the same period of 20 ms. Alternatively, an offset may be defined or configured by high layer signaling so that the LP-WUSs in a LP-WUS burst in a k_th period of 20 ms may be respectively associated with the CORESET 0 in (k+x)_th period of 20 ms, k, x are integer numbers.

In one option, the same algorithm for timing determination of Type0 CSS set by M and O can be reused for LP-WUS. The same parameters M and O which are used to determine the timing of Type0 CSS set may be applicable to determine the timing of LP-WUSs in a LP-WUS burst. With this mapping pattern, a LP-WUS in a slot can use the same beam as the Type0 CSS set of a SSB. Alternatively, the separate parameters M and O can be configured which are used to determine the timing of LP-WUSs in a LP-WUS burst.

In one example for the LP-WUS burst in a period of 20 ms with SCS 15 kHz with parameters 0=0, M=1, each of the first 8 subframes in the even frame can contain a LP-WUS. A LP-WUS may occupy OFDM symbol index 2 to 11 in a slot.

In one example for the LP-WUS burst in a period of 20 ms with SCS 15 kHz with parameters 0=5, M=2, each of the 8 subframes in the 20 ms can contain a LP-WUS. A LP-WUS may occupy OFDM symbol index 2 to 11 in a slot.

In another option, the timing of LP-WUSs in a LP-WUS burst in a period of 20 ms can be determined by a new algorithm which is different from Type0 CSS set determination.

### Duty-Cycle-Based LP-WUS Detection:

In one or more embodiments, the configuration of LP-WUS transmission may include the following parameters: periodicity, offset of the first LP-WUS burst, and number of LP-WUS bursts in a period. The periodicity may be same or different from the periodicity of SSB transmission. Such configuration on the LP-WUS transmission can be referred as duty-cycle based configuration, where the cycle means the periodicity. A UE can detect a LP-WUS based on duty-cycle configuration of LP-WUS burst when the UE needs to monitor wake-up information. Once a LP-WUS in a LP-WUS burst is detected, UE can know the associated SSB index from the LP-WUS index in the LP-WUS burst. Consequently, if UE needs to monitor paging according to the indication of the LP-WUS, the UE can monitor PO/PEI for the UE which is at least a period X after the detected LP-WUS. X can be predefined, preconfigured, configured by high layer signaling or reported by UE as UE capability, e.g., the period X is the transition time for the UE to wake up the main radio.

In one example on duty-cycle based LP-WUS detection, each LP-WUS burst consists of 8 LP-WUS respectively associated with 8 SSB indexes. It is assumed that the UE detects a LP-WUS for SSB index 2. Consequently, the UE can monitor a paging PDCCH using the same SSB index 2 after an time interval for waking up and sync/resync.

In one or more embodiments, a UE can detect LP-WUS in all LP-WUS bursts when the UE needs to monitor wake-up information. Assuming a LP-WUS burst is defined in a period of K ms, the UE can monitor LP-WUS in every K ms periods. In other words, it can be considered as duty-cycle based configuration with periodicity of K ms. Once a LP-WUS in a LP-WUS burst is detected, UE can know the associated SSB index from the LP-WUS index in the LP-WUS burst. Consequently, the UE can monitor PO/PEI for the UE which is at least a period X after the detected LP-WUS. X can be predefined, preconfigured, configured by high layer signaling or reported by UE as UE capability, e.g., the period X is the transition time for the UE to wake up the main radio.

### LP-WUS Burst Determined by Paging Frame/Paging Occasion:

In one or more embodiments, a LP-WUS can be associated with the Type0 CSS set which is determined by the paging frame and paging occasion for a UE in paging operation. In 3GPP TS 38.304, the following behavior for PF/PO determination is defined:

The PF and PO for paging are determined by the following formulae:

SFN for the PF is determined by:

$$( SFN + PF\_offset ) mod T = ( T div N ) * ( UE\_ID mod N )$$

Index (i_s), indicating the index of the PO is determined by:

$$i\_s = floor ( UE\_ID / N ) mod Ns$$

The PDCCH monitoring occasions for paging are determined according to pagingSearchSpace as specified in TS 38.213 and firstPDCCH-MonitoringOccasionOfPO and nrofPDCCH-MonitoringOccasionPerSSB-InPO if configured as specified in TS 38.331 [3]. When SearchSpaceId=0 is configured for pagingSearchSpace, the PDCCH monitoring occasions for paging are same as for RMSI as defined in clause 13 in TS 38.213.

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

In one option, there can be a time interval between a LP-WUS and its associated Type0 CSS set that is determined by the PF/PO for paging operation. The time interval is for the main radio to wake up and do synchronization/resynchronization. For example, the time interval can be hundreds of millisecond or several seconds. The time interval can be up to UE capability and/or high layer configuration.

In one example on the association between the LP-WUS and the Type0 CSS set of a PF/PO for paging operation, a LP-WUS for a SSB index is earlier than the associated Type0 CSS set for the SSB index by a time interval for waking up and sync/resync. It may be assumed that the UE detects a LP-WUS for SSB index 2. Consequently, the UE can monitor the associated paging PDCCH using the same SSB index 2 after the time interval for waking up and sync/resync.

In one or more embodiments, a set of LP-WUSs, i.e., a LP-WUS burst can be associated with the transmitted SSBs in order. The LP-WUS burst can be associated with the paging frame and paging occasion for a UE in paging operation. In TS 38.304, the following behavior for PF/PO determination is defined:

The PF and PO for paging are determined by the following formulae:

SFN for the PF is Determined by:

$$( SFN + PF\_offset ) mod T = ( T div N ) * ( UE\_ID mod N )$$

Index (is), indicating the index of the PO is determined by:

$$i\_s = floor ( UE\_ID / N ) mod Ns .$$

The PDCCH monitoring occasions for paging are determined according to pagingSearchSpace as specified in TS 38.213 and firstPDCCH-MonitoringOccasionOfPO and nrofPDCCH-MonitoringOccasionPerSSB-InPO if configured as specified in TS 38.331.

. . .

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

NOTE 1: A PO associated with a PF may start in the PF or after the PF.

NOTE 2: The PDCCH monitoring occasions for a PO can span multiple radio frames. When SearchSpaceId other than 0 is configured for paging-SearchSpace the PDCCH monitoring occasions for a PO can span multiple periods of the paging search space.

Corresponding to a (i_s+1)^{th} PO, a LP-WUS burst is a set of ‘S*X’ consecutive LP-WUS where ‘S’ is the number of actual transmitted SSBs determined according to ssb-PositionsInBurst in SIB1 and X is the parameter nrofPDCCH-MonitoringOccasionPerSSB-InPO-LPWUS if configured or is equal to 1 otherwise. The [x*S+K]^{th} LP-WUS in the LP-WUS burst corresponds to the K^{th} transmitted SSB, where x=0, 1, . . . , X−1, K=1, 2, . . . , S. The LP-WUSs which do not overlap with UL symbols (determined according to tdd-UL-DL-ConfigurationCommon) are sequentially numbered from zero starting from the first LP-WUS in the frame for LP-WUS burst determination.

There can be a time interval between the frame for LP-WUS burst determination and the PF for paging operation. The time interval is for the main radio to wake up and do synchronization/resynchronization. The time interval may be integer number of frames. For example, the time interval can be hundreds of millisecond or several seconds. The time interval can be up to UE capability and/or high layer configuration by gNB.

When firstPDCCH-MonitoringOccasionOfPO-LPWUS is present, the starting LP-WUS number of (i_s+1)^{th} PO is the (i_s+1)^{th} value of the firstPDCCH-MonitoringOccasionOfPO-LPWUS parameter; otherwise, it is equal to i_s*S*X. If X>1, when the UE detects a LP-WUS in the LP-WUS burst, the UE is not required to monitor the other LP-WUS in the LP-WUS burst.

In one option, the following parameters nrofPDCCH-MonitoringOccasionPerSSB-InPO-LPWUS and firstPDCCH-MonitoringOccasionOfPO-LPWUS can be respectively the same parameters nrofPDCCH-MonitoringOccasionPerSSB-InPO and firstPDCCH-MonitoringOccasionOfPO configured for paging operation.

In another option, one, multiple or all the following parameters can be separately configured for LP-WUS burst determination: nrofPDCCH-MonitoringOccasionPerSSB-InPO-LPWUS and firstPDCCH-MonitoringOccasionOfPO-LPWUS. For example, S is same for LP-WUS and PDCCH MO for paging, while X is separately configured, e.g., Xp=1 for PDCCH MO for paging while Xw>1 for LP-WUS. Then, Xw/Xp LP-WUSs are associated with one MO in the PO.

In one example to determine a LP-WUS that is associated with a PF/PO for paging operation, it may be assumed that SearchSpaceId other than 0 is configured for pagingSearchSpace, a set of PDCCH monitoring occasion (MO) can be determined for the PO. Correspondingly, a set of LP-WUS, i.e., the LP-WUS burst can be determined which is earlier than the determined set of PDCCH MOs by the interval for waking up and sync/resync. It may be assumed that the UE will use LP-WUS for SSB index 2 and the associated PDCCH MO for paging for SSB index 2.

A LP-WUS Associated with an Actual Transmitted SSB:

The number of beams M for LP-WUSs in a LP-WUS burst can be different from the number of beams N for SSBs in a SSB burst. Then, the association between a LP-WUS and a SSB should be defined. The LP-WUS does not overlap with UL symbols (determined according to tdd-UL-DL-ConfigurationCommon).

In one or more embodiments, with L≥1, L consecutive SSBs are associated with one LP-WUS. The SSBs with SSB index s, s=j*L+i, i=0, 1, . . . L−1, are associated with j-th LP-WUS. Alternatively, SSB index s, s=i*L+j, i=0, 1, . . . L−1, are associated with j-th LP-WUS. If L<1, 1/L consecutive LP-WUSs are associated with one SSB. The LP-WUSs with index s, s=j*L+i, i=0, 1, . . . 1/L−1, are associated with SSB index j. Alternatively, LP-WUS index s, s=i*L+j, i=0, 1, . . . 1/L−1, are associated with SSB index j.

In one or more embodiments, the [x*M+m]^{th} LP-WUS in the LP-WUS burst corresponds to the K^{th} transmitted SSB, where x=0, 1, . . . , X−1, m=0, 1, . . . , M−1, K=m*L+0, 1, . . . L−1, if L≥1, otherwise, K=ceil(m*L). X is nrofPDCCH-MonitoringOccasionPerSSB-InPO-LPWUS, M is the number of beams for LP-WUS, and L is defined above. Similarly, the association between a LP-WUS with a beam and a PO with the beam can be determined.

In one or more embodiments, a beam for a LP-WUS and the associated beam for a SSB or PO is with qcl-Type set to “typeD.”

The above descriptions are for purposes of illustration and are not meant to be limiting. Numerous other examples, configurations, processes, algorithms, etc., may exist, some of which are described in greater detail below. Example embodiments will now be described with reference to the accompanying figures.

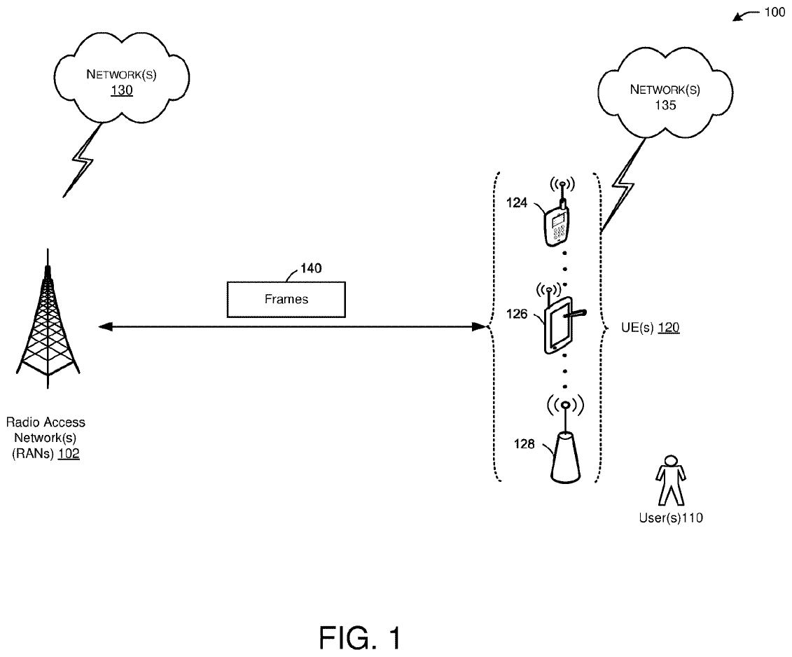

FIG. 1 is a network diagram illustrating an example network environment 100, in accordance with one or more example embodiments of the present disclosure.

Wireless network 100 may include one or more UEs 120 and one or more RANs 102 (e.g., gNBs), which may communicate in accordance with 3GPP communication standards. The UE(s) 120 may be mobile devices that are non-stationary (e.g., not having fixed locations) or may be stationary devices.

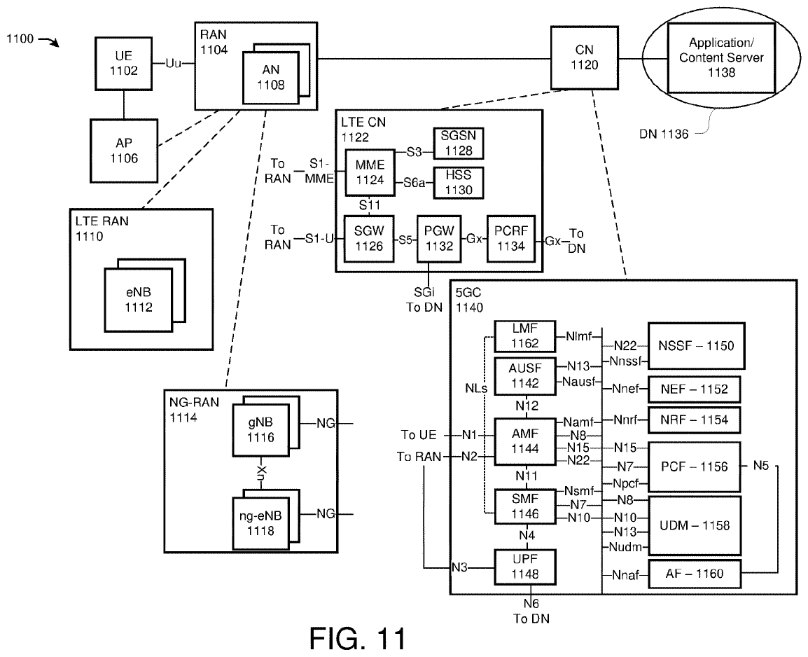

In some embodiments, the UEs 120 and the RANs 102 may include one or more computer systems similar to that of FIGS. 11-13.

One or more illustrative UE(s) 120 and/or RAN(s) 102 may be operable by one or more user(s) 110. A UE may take on multiple distinct characteristics, each of which shape its function. For example, a single addressable unit might simultaneously be a portable UE, a quality-of-service (QoS) UE, a dependent UE, and a hidden UE. The UE(s) 120 (e.g., 124, 126, or 128) and/or RAN(s) 102 may include any suitable processor-driven device including, but not limited to, a mobile device or a non-mobile, e.g., a static device. For example, UE(s) 120 may include, a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE(s) 120 (e.g., UEs 124, 126, 128), and UE(s) 120 may be configured to communicate with each other via one or more communications networks 130 and/or 135 wirelessly or wired. The UE(s) 120 may also communicate peer-to-peer or directly with each other with or without the RAN(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, cellular networks. In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the UE(s) 120 (e.g., UE 124, 126, 128) and RAN(s) 102 may include one or more communications antennas. The one or more communications antennas may be any suitable type of antennas corresponding to the communications protocols used by the UE(s) 120 (e.g., UEs 124, 126 and 128), and RAN(s) 102. Some non-limiting examples of suitable communications antennas include cellular antennas, 3GPP family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UEs 120 and/or RAN(s) 102.

Any of the UE(s) 120 (e.g., UE 124, 126, 128), and RAN(s) 102 may be configured to perform directional transmission and/or directional reception in conjunction with wirelessly communicating in a wireless network. Any of the UE(s) 120 (e.g., UE 124, 126, 128), and RAN(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the UE(s) 120 (e.g., UE 124, 126, 128), and RAN(s) 102 may be configured to perform any given directional transmission towards one or more defined transmit sectors. Any of the UE(s) 120 (e.g., UE 124, 126, 128), and RAN(s) 102 may be configured to perform any given directional reception from one or more defined receive sectors.

MIMO beamforming in a wireless network may be accomplished using RF beamforming and/or digital beamforming. In some embodiments, in performing a given MIMO transmission, UE 120 and/or RAN(s) 102 may be configured to use all or a subset of its one or more communications antennas to perform MIMO beamforming.

Any of the UE 120 (e.g., UE 124, 126, 128), and RAN(s) 102 may include any suitable radio and/or transceiver for transmitting and/or receiving radio frequency (RF) signals in the bandwidth and/or channels corresponding to the communications protocols utilized by any of the UE(s) 120 and RAN(s) 102 to communicate with each other. The radio components may include hardware and/or software to modulate and/or demodulate communications signals according to pre-established transmission protocols. The radio components may further have hardware and/or software instructions to communicate via one or more 3GPP protocols and using 3GPP bandwidths. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more of the UEs 120 may exchange frames 140 with the RANs 102. The frames 140 may include UL and DL frames, including LP-WUS signaling, paging, and other frames and signaling described in the present disclosure.

It is understood that the above descriptions are for purposes of illustration and are not meant to be limiting.

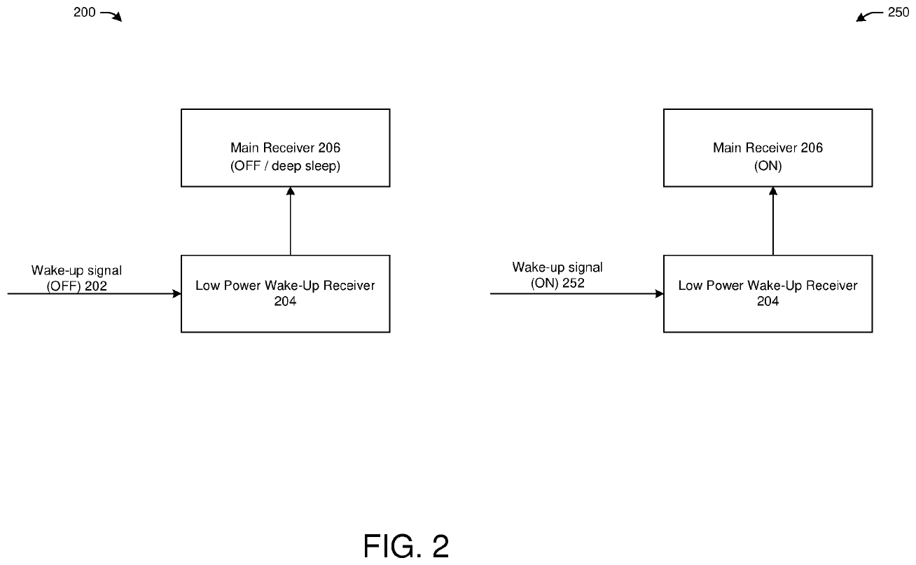

FIG. 2 illustrates example processes for controlling a main receiver with a low-power wake-up receiver, in accordance with one or more example embodiments of the present disclosure.

Referring to FIG. 2, a process 200 may include a wake-up signal 202 may be received by a low-power wake-up receiver (LP-WUR) 204 of a device (e.g., of any of the UEs 120 of FIG. 1), and may indicate that a collocated main receiver 206 of the same device may be turned off In response, the LP-WUR 204 may signal to the main receiver 206 that the main receiver 206 may be turned off A process 250 may include a wake-up signal 252 received by the LP-WUR 204, indicating that the main receiver 206 should wake-up to a normal (e.g., higher power) mode. As a result, the LP-WUR 204 may signal to the main receiver 206 to wake up/turn on.

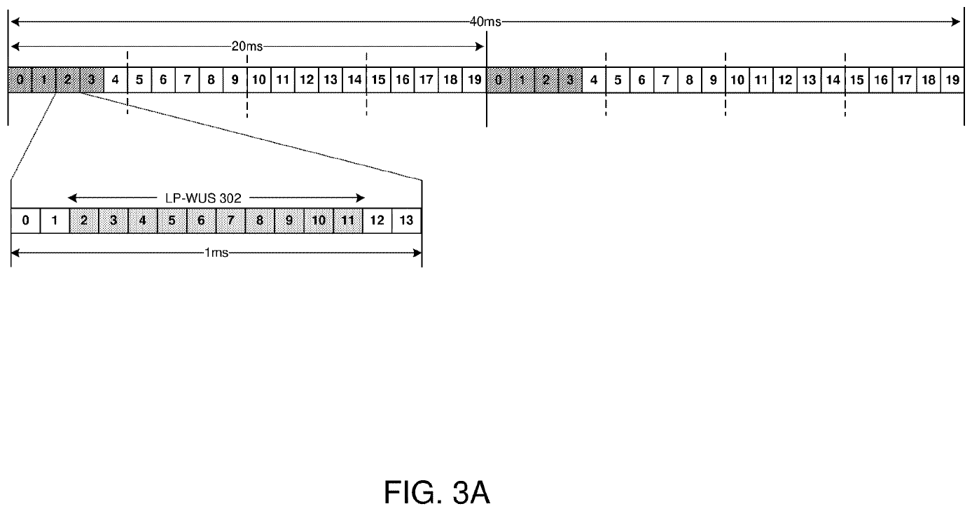

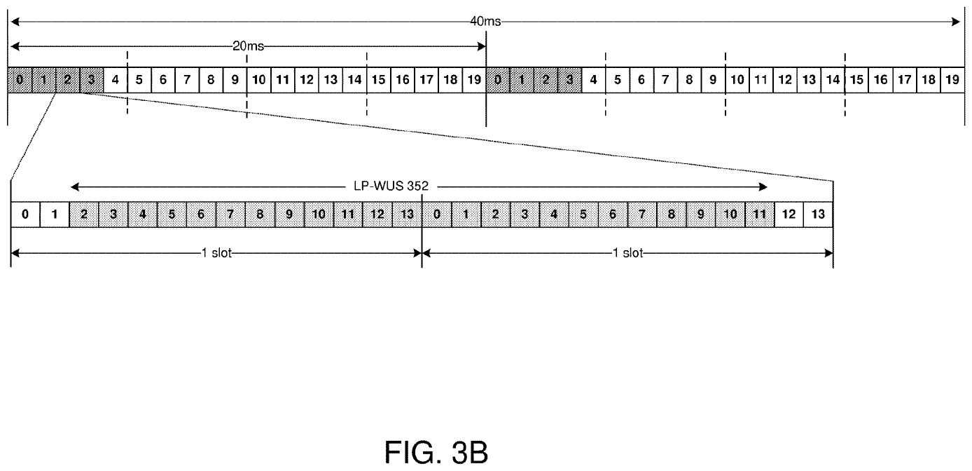

FIG. 3A illustrates an example of up to four low-power wake-up signals (LP-WUSs) in a half-frame with subcarrier spacing of 15 kHz, in accordance with one or more example embodiments of the present disclosure.

Referring to FIG. 3A, a LP-WUS 302 may be transmitted in a burst within a half-frame of 20 ms duration. When the LP-WUS 302 is configured during the same 20 ms half-frame duration as a SSB, a beam of the LP-WUS 302 may need to align with a beam of the SSB, or the LP-WUS may be configured in a different half-frame than a SSB burst. As shown in FIG. 3A, up to four LP-WUSs in a LP-WUS burst may be transmitted within one half-frame (e.g., represented by the 20 ms duration). In FIG. 3A, the SCS is 15 kHZ, and each of the first four slots in the 20 ms half-frame (e.g., slots 0-3) may include a LP-WUS (e.g., the LP-WUS 302 shown for slot 2 of the 20 ms half-frame). The LP-WUS 302 may occupy OFDM symbol indices 2-11 (e.g., of symbol indices 0-13) in a slot.

FIG. 3B illustrates an example of up to four LP-WUSs in a half-frame with subcarrier spacing of 30 kHz, in accordance with one or more example embodiments of the present disclosure.

Referring to FIG. 3A, a LP-WUS 352 may be transmitted in a burst within a half-frame of 20 ms duration. As shown in FIG. 3B, up to four LP-WUSs in a LP-WUS burst may be transmitted within one half-frame (e.g., represented by the 20 ms duration). In FIG. 3B, the SCS is 30 kHZ, and each of the first four slots in the 20 ms half-frame (e.g., slots 0-3) may include a LP-WUS (e.g., the LP-WUS 352 shown for slot 2 of the 20 ms half-frame). The LP-WUS 352 may occupy OFDM symbol indices 2-13 (e.g., of symbol indices 0-13) in a first slot and symbol indices 0-11 (e.g., of symbol indices 0-13) in a second slot.

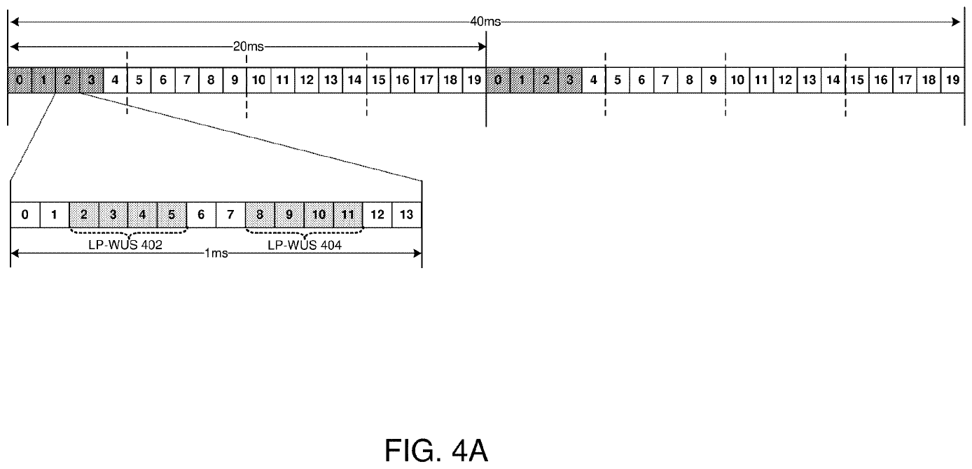

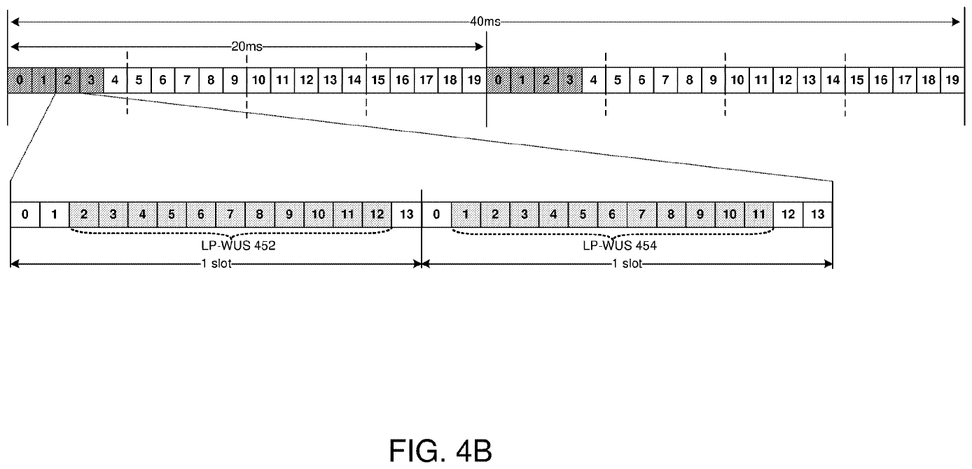

FIG. 4A illustrates an example of up to eight LP-WUSs in a half-frame with subcarrier spacing of 15 kHz, in accordance with one or more example embodiments of the present disclosure.

Referring to FIG. 4A, LP-WUS 402 and LP-WUS 404 are shown as transmitted within a same 20 ms half-frame with SCS of 15 kHz. Each of the first four slots (e.g., slots 0-3) of the 20 ms half-frame may include two LP-WUSs (e.g., slot 2 shows the LP-WUS 402 and the LP-WUS 404), which may occupy OFDM symbol indices 2-5 and 8-11, respectively, of OFDM symbol indices 0-13.

FIG. 4B illustrates an example of up to eight LP-WUSs in a half-frame with subcarrier spacing of 30 kHz, in accordance with one or more example embodiments of the present disclosure.

Referring to FIG. 4B, LP-WUS 452 and LP-WUS 454 are shown as transmitted within a same 20 ms half-frame with SCS of 30 kHz. Each of the first four slots (e.g., slots 0-3) of the 20 ms half-frame may include two LP-WUSs (e.g., slot 2 shows the LP-WUS 452 and the LP-WUS 454), which may occupy OFDM symbol indices 2-12 and 1-11, respectively, of OFDM symbol indices 0-13.

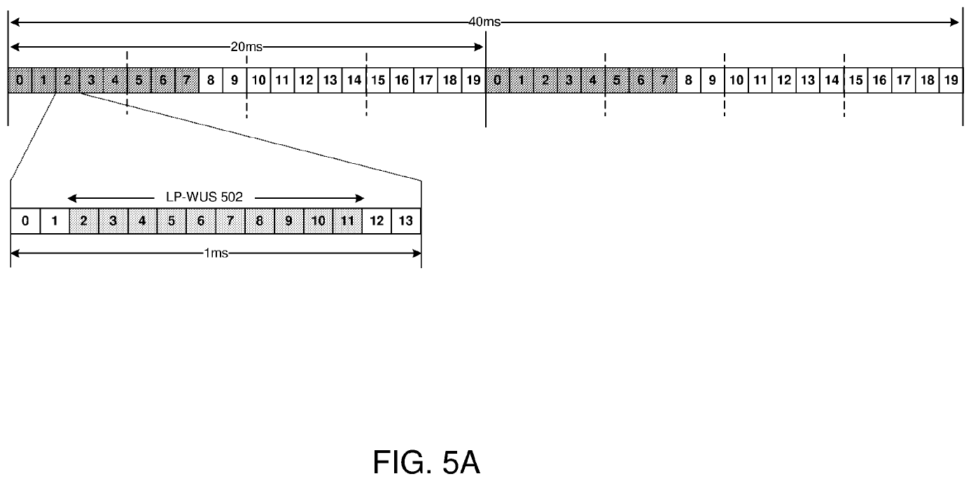

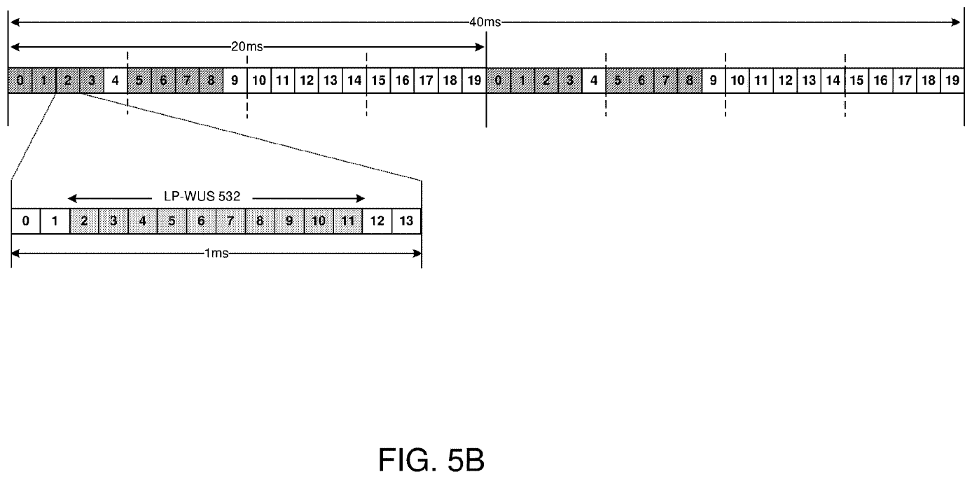

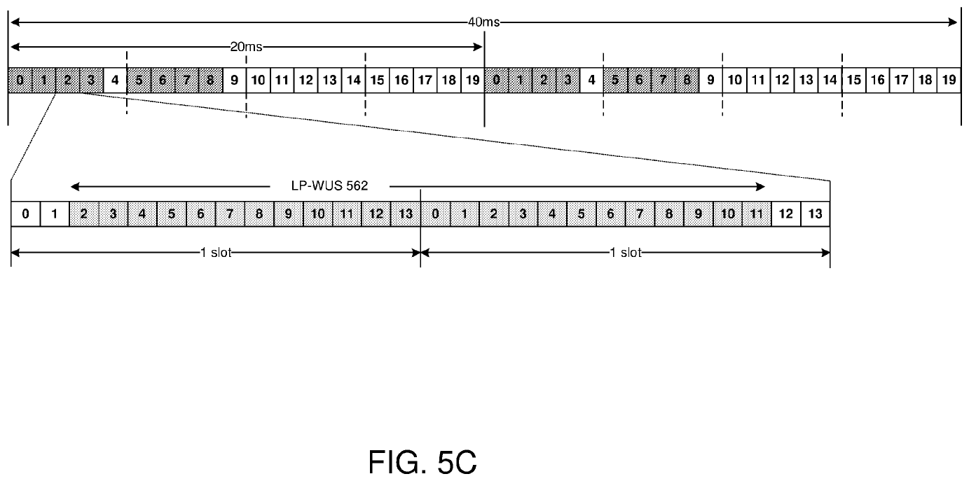

FIG. 5A illustrates an example of up to eight LP-WUSs in a frame with subcarrier spacing of 15 kHz, in accordance with one or more example embodiments of the present disclosure.

Referring to FIG. 5A, LP-WUSs (e.g., LP-WUS 502) may be transmitted in a burst in a frame with SCS of 15 kHZ. Each of the first eight subframes (e.g., subframes 0-7 as shown) in a frame (e.g., of 20 ms consisting of subframes 0-19) may contain a LP-WUS (e.g., subframe 2 includes the LP-WUS 502). A LP-WUS may occupy OFDM symbol indices 2-11 (e.g., of OFDM symbol indices 0-13) in a slot.

FIG. 5B illustrates an example of up to eight LP-WUSs in a frame with subcarrier spacing of 15 kHz, in accordance with one or more example embodiments of the present disclosure.

Referring to FIG. 5B, LP-WUSs (e.g., LP-WUS 532) may be transmitted in a burst in a frame with SCS of 15 kHZ. Each of subframes 0-3 and 5-8 in a frame (e.g., of 20 ms consisting of subframes 0-19) may contain a LP-WUS (e.g., subframe 2 includes the LP-WUS 532). A LP-WUS may occupy OFDM symbol indices 2-11 (e.g., of OFDM symbol indices 0-13) in a slot.

FIG. 5C illustrates an example of up to eight LP-WUSs in a frame with subcarrier spacing of 30 kHz, in accordance with one or more example embodiments of the present disclosure.

Referring to FIG. 5C, LP-WUSs (e.g., LP-WUS 562) may be transmitted in a burst in a frame with SCS of 30 kHZ. Each of subframes 0-3 and 5-8 in a frame (e.g., of 20 ms consisting of subframes 0-19) may contain a LP-WUS (e.g., subframe 2 includes the LP-WUS 532). A LP-WUS may occupy OFDM symbol indices 2-13 (e.g., of OFDM symbol indices 0-13) in a first slot and OFDM symbol indices 0-11 in a second slot (e.g., of OFDM symbol indices 0-13).

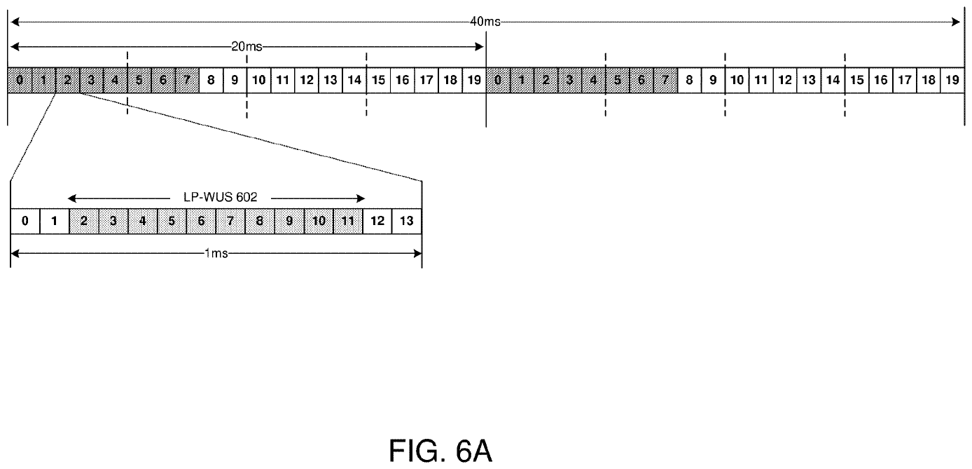

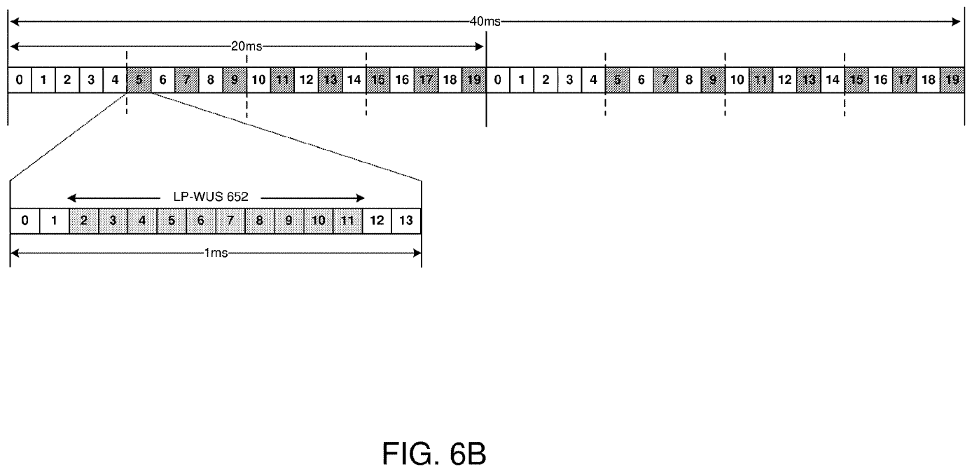

FIG. 6A illustrates an example of a LP-WUS burst with subcarrier spacing of 15 kHz, in accordance with one or more example embodiments of the present disclosure.

Referring to FIG. 6A, LP-WUSs (e.g., LP-WUS 602) may be transmitted in a burst in a period of 20 ms with SCS of 15 kHz and parameters 0=0, M=1. Each of the first eight subframes (e.g., subframes 0-7 as shown) of an even frame (e.g., consisting of symbols 0-19) may contain a LP-WUS (e.g., the subframe 2 includes the LP-WUS 602), and any LP-WUS may occupy OFDM symbol indices 2-11 (e.g., of OFDM symbol indices 0-13) in a slot.

FIG. 6B illustrates an example of a LP-WUS burst with subcarrier spacing of 15 kHz, in accordance with one or more example embodiments of the present disclosure.

Referring to FIG. 6B, LP-WUSs (e.g., LP-WUS 652) may be transmitted in a burst in a period of 20 ms with SCS of 15 kHz and parameters 0=5, M=2. Each of the first eight subframes (e.g., subframes 0-7 as shown) of an even frame (e.g., consisting of symbols 0-19) may contain a LP-WUS (e.g., the subframe 2 includes the LP-WUS 652), and any LP-WUS may occupy OFDM symbol indices 2-11 (e.g., of OFDM symbol indices 0-13) in a slot.

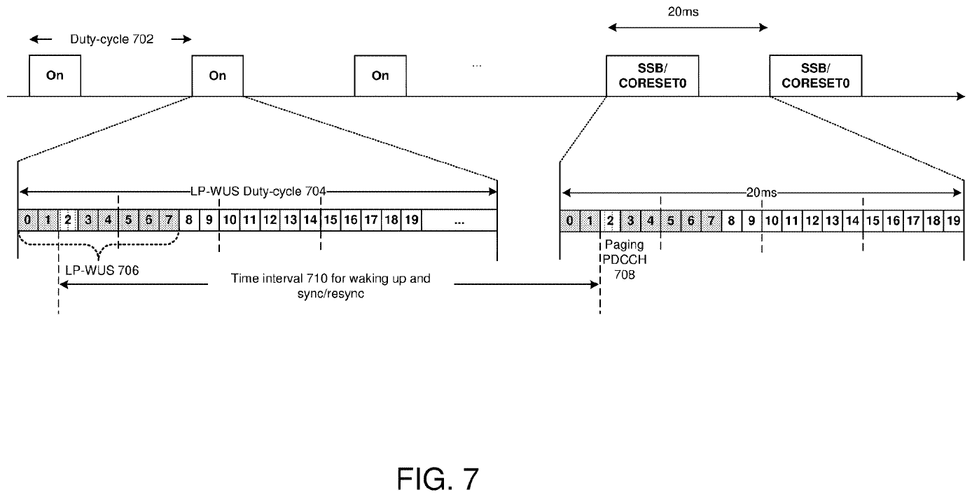

FIG. 7 illustrates an example of duty-cycle-based LP-WUS detection, in accordance with one or more example embodiments of the present disclosure.

Referring to FIG. 7, a duty cycle 702 between respective times when a device turns on its main radio may include a LP-WUS duty cycle 704 when a LP-WUS burst may be transmitted. A LP-WUS burst may consist of eight LP-WUSs 706 using eight SSB indices (e.g., SSB indices 0-7 of SSB indices 0-19). As a result, a UE may monitor a paging PDCCH 708 using the same SSB index 2 after a time interval 710 for waking up and performing sync/resync.

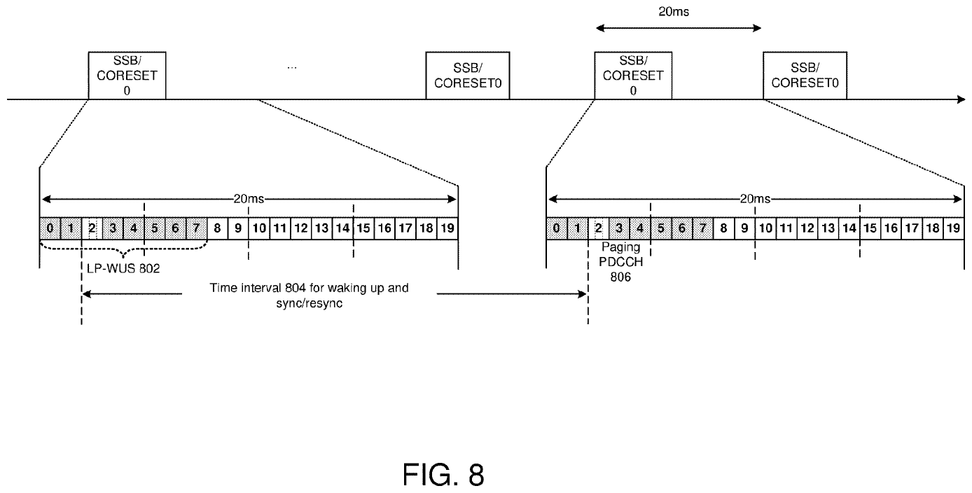

FIG. 8 illustrates an example LP-WUS associated with a paging frame and paging occasion for a paging operation, in accordance with one or more example embodiments of the present disclosure.

Referring to FIG. 8, LP-WUSs 802 may be associated with a Type0 CSS set of a PF/PO paging operation. A LP-WUS for a SSB index may be earlier than the associated Type0 CSS set for the SSB index by a time interval 804 for waking up and performing a sync/resync. For example, a UE may detect the LP-WUSs 802 for SSB index 2 (e.g., a LP-WUS consisting of SSB indices 0-7 of SSB indices 0-19). As a result, the UE may monitor the associated paging PDCCH 806 using the same SSB index 2 after the time interval 804.

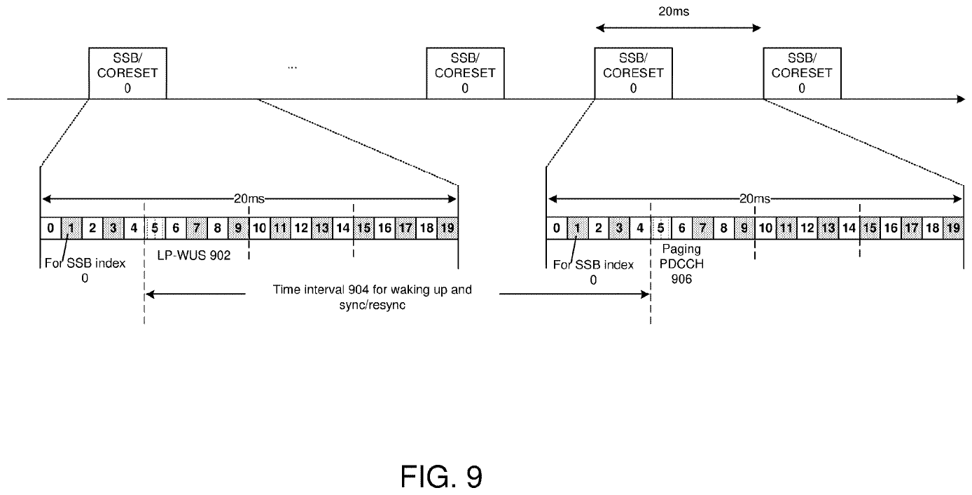

FIG. 9 illustrates an example LP-WUS associated with a paging frame and paging occasion for a paging operation, in accordance with one or more example embodiments of the present disclosure.

FIG. 9 illustrates one example to determine a LP-WUS 902 that is associated with a PF/PO for paging operation. It is assumed that SearchSpaceId other than 0 is configured for pagingSearchSpace, a set of PDCCH monitoring occasion (MO) can be determined for the PO. Correspondingly, a set of LP-WUS, i.e., the LP-WUS burst can be determined, which is earlier than the determined set of PDCCH MOs by an interval 904 for waking up and performing a sync/resync. In FIG. 9, it is assumed that the UE will use LP-WUS for SSB index 2 and the associated PDCCH MO for paging for SSB index 2 (e.g. using paging PDCCH 906).

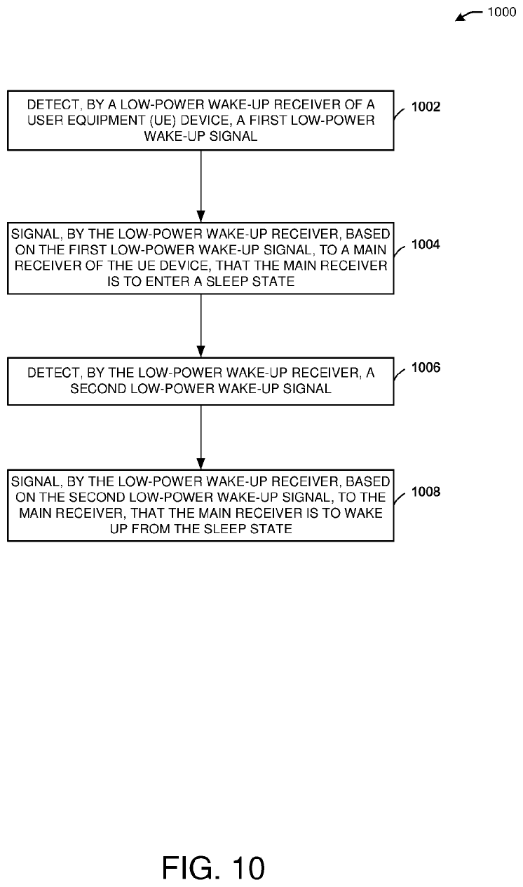

FIG. 10 illustrates a flow diagram of illustrative process 1000 for beam-based LP-WUS, in accordance with one or more example embodiments of the present disclosure.

At block 1002, a device (or system, e.g., an of the UEs 120 of FIG. 1, the UE 1102 of FIG. 11) may detect, using a low-power wake-up receiver (e.g., the low-power wake-up receiver 204 of FIG. 2) a first low-power wake-up signal.

At block 1004, the device may signal, using the low-power wake-up receiver, to a main receiver (e.g., the main receiver 206 of FIG. 2), based on the first low-power wake-up signal, that the main receiver is to enter sleep state.

At block 1006, the device may detect, using the low-power wake-up receiver, a second low-power wake-up signal.

At block 1008, the device may signal, by the low-power wake-up receiver, to the main receiver, based on the second low-power wake-up signal, that the main radio is to wake up from the sleep state.

These embodiments are not meant to be limiting.

FIG. 11 illustrates a network 1100 in accordance with various embodiments. The network 1100 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1100 may include a UE 1102, which may include any mobile or non-mobile computing device designed to communicate with a RAN 1104 via an over-the-air connection. The UE 1102 may be communicatively coupled with the RAN 1104 by a Uu interface. The UE 1102 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1100 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1102 may additionally communicate with an AP 1106 via an over-the-air connection. The AP 1106 may manage a WLAN connection, which may serve to offload some/all network traffic from the RAN 1104. The connection between the UE 1102 and the AP 1106 may be consistent with any IEEE 802.11 protocol, wherein the AP 1106 could be a wireless fidelity (Wi-Fi®) router. In some embodiments, the UE 1102, RAN 1104, and AP 1106 may utilize cellular-WLAN aggregation (for example, LWA/LWIP). Cellular-WLAN aggregation may involve the UE 1102 being configured by the RAN 1104 to utilize both cellular radio resources and WLAN resources.

The RAN 1104 may include one or more access nodes, for example, AN 1108. AN 1108 may terminate air-interface protocols for the UE 1102 by providing access stratum protocols including RRC, PDCP, RLC, MAC, and L1 protocols. In this manner, the AN 1108 may enable data/voice connectivity between CN 1120 and the UE 1102. In some embodiments, the AN 1108 may be implemented in a discrete device or as one or more software entities running on server computers as part of, for example, a virtual network, which may be referred to as a CRAN or virtual baseband unit pool. The AN 1108 be referred to as a BS, gNB, RAN node, eNB, ng-eNB, NodeB, RSU, TRxP, TRP, etc. The AN 1108 may be a macrocell base station or a low power base station for providing femtocells, picocells or other like cells having smaller coverage areas, smaller user capacity, or higher bandwidth compared to macrocells.

In embodiments in which the RAN 1104 includes a plurality of ANs, they may be coupled with one another via an X2 interface (if the RAN 1104 is an LTE RAN) or an Xn interface (if the RAN 1104 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1104 may each manage one or more cells, cell groups, component carriers, etc. to provide the UE 1102 with an air interface for network access. The UE 1102 may be simultaneously connected with a plurality of cells provided by the same or different ANs of the RAN 1104. For example, the UE 1102 and RAN 1104 may use carrier aggregation to allow the UE 1102 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1104 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1102 or AN 1108 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1104 may be an LTE RAN 1110 with eNBs, for example, eNB 1112. The LTE RAN 1110 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1104 may be an NG-RAN 1114 with gNBs, for example, gNB 1116, or ng-eNBs, for example, ng-eNB 1118. The gNB 1116 may connect with 5G-enabled UEs using a 5G NR interface. The gNB 1116 may connect with a 5G core through an NG interface, which may include an N2 interface or an N3 interface. The ng-eNB 1118 may also connect with the 5G core through an NG interface, but may connect with a UE via an LTE air interface. The gNB 1116 and the ng-eNB 1118 may connect with each other over an Xn interface.

In some embodiments, the NG interface may be split into two parts, an NG user plane (NG-U) interface, which carries traffic data between the nodes of the NG-RAN 1114 and a UPF 1148 (e.g., N3 interface), and an NG control plane (NG-C) interface, which is a signaling interface between the nodes of the NG-RAN 1114 and an AMF 1144 (e.g., N2 interface).

The NG-RAN 1114 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1102 can be configured with multiple BWPs where each BWP configuration has a different SCS. When a BWP change is indicated to the UE 1102, the SCS of the transmission is changed as well. Another use case example of BWP is related to power saving. In particular, multiple BWPs can be configured for the UE 1102 with different amount of frequency resources (for example, PRBs) to support data transmission under different traffic loading scenarios. A BWP containing a smaller number of PRBs can be used for data transmission with small traffic load while allowing power saving at the UE 1102 and in some cases at the gNB 1116. A BWP containing a larger number of PRBs can be used for scenarios with higher traffic load.

The RAN 1104 is communicatively coupled to CN 1120 that includes network elements to provide various functions to support data and telecommunications services to customers/subscribers (for example, users of UE 1102). The components of the CN 1120 may be implemented in one physical node or separate physical nodes. In some embodiments, NFV may be utilized to virtualize any or all of the functions provided by the network elements of the CN 1120 onto physical compute/storage resources in servers, switches, etc. A logical instantiation of the CN 1120 may be referred to as a network slice, and a logical instantiation of a portion of the CN 1120 may be referred to as a network sub-slice.

In some embodiments, the CN 1120 may be an LTE CN 1122, which may also be referred to as an EPC. The LTE CN 1122 may include MME 1124, SGW 1126, SGSN 1128, HSS 1130, PGW 1132, and PCRF 1134 coupled with one another over interfaces (or “reference points”) as shown. Functions of the elements of the LTE CN 1122 may be briefly introduced as follows.

The MME 1124 may implement mobility management functions to track a current location of the UE 1102 to facilitate paging, bearer activation/deactivation, handovers, gateway selection, authentication, etc.

The SGW 1126 may terminate an S1 interface toward the RAN and route data packets between the RAN and the LTE CN 1122. The SGW 1126 may be a local mobility anchor point for inter-RAN node handovers and also may provide an anchor for inter-3GPP mobility. Other responsibilities may include lawful intercept, charging, and some policy enforcement.

The SGSN 1128 may track a location of the ULE 1102 and perform security functions and access control. In addition, the SGSN 1128 may perform inter-EPC node signaling for mobility between different RAT networks; PDN and S-GW selection as specified by MME 1124; MME selection for handovers; etc. The S3 reference point between the MME 1124 and the SGSN 1128 may enable user and bearer information exchange for inter-3GPP access network mobility in idle/active states.

The HSS 1130 may include a database for network users, including subscription-related information to support the network entities' handling of communication sessions. The HSS 1130 can provide support for routing/roaming, authentication, authorization, naming/addressing resolution, location dependencies, etc. An S6a reference point between the HSS 1130 and the MME 1124 may enable transfer of subscription and authentication data for authenticating/authorizing user access to the LTE CN 1120.

The PGW 1132 may terminate an SGi interface toward a data network (DN) 1136 that may include an application/content server 1138. The PGW 1132 may route data packets between the LTE CN 1122 and the data network 1136. The PGW 1132 may be coupled with the SGW 1126 by an SS reference point to facilitate user plane tunneling and tunnel management. The PGW 1132 may further include a node for policy enforcement and charging data collection (for example, PCEF). Additionally, the SGi reference point between the PGW 1132 and the data network 1136 may be an operator external public, a private PDN, or an intra-operator packet data network, for example, for provision of IMS services. The PGW 1132 may be coupled with a PCRF 1134 via a Gx reference point.

The PCRF 1134 is the policy and charging control element of the LTE CN 1122. The PCRF 1134 may be communicatively coupled to the app/content server 1138 to determine appropriate QoS and charging parameters for service flows. The PCRF 1132 may provision associated rules into a PCEF (via Gx reference point) with appropriate TFT and QCI.

In some embodiments, the CN 1120 may be a 5GC 1140. The 5GC 1140 may include an AUSF 1142, AMF 1144, SMF 1146, UPF 1148, NSSF 1150, NEF 1152, NRF 1154, PCF 1156, UDM 1158, and AF 1160 coupled with one another over interfaces (or “reference points”) as shown. Functions of the elements of the 5GC 1140 may be briefly introduced as follows.

The AUSF 1142 may store data for authentication of UE 1102 and handle authentication-related functionality. The AUSF 1142 may facilitate a common authentication framework for various access types. In addition to communicating with other elements of the 5GC 1140 over reference points as shown, the AUSF 1142 may exhibit an Nausf service-based interface.

The AMF 1144 may allow other functions of the 5GC 1140 to communicate with the UE 1102 and the RAN 1104 and to subscribe to notifications about mobility events with respect to the UE 1102. The AMF 1144 may be responsible for registration management (for example, for registering UE 1102), connection management, reachability management, mobility management, lawful interception of AMF-related events, and access authentication and authorization. The AMF 1144 may provide transport for SM messages between the UE 1102 and the SMF 1146, and act as a transparent proxy for routing SM messages. AMF 1144 may also provide transport for SMS messages between UE 1102 and an SMSF. AMF 1144 may interact with the AUSF 1142 and the UE 1102 to perform various security anchor and context management functions. Furthermore, AMF 1144 may be a termination point of a RAN CP interface, which may include or be an N2 reference point between the RAN 1104 and the AMF 1144; and the AMF 1144 may be a termination point of NAS (N1) signaling, and perform NAS ciphering and integrity protection. AMF 1144 may also support NAS signaling with the UE 1102 over an N3 IWF interface.

The SMF 1146 may be responsible for SM (for example, session establishment, tunnel management between UPF 1148 and AN 1108); UE IP address allocation and management (including optional authorization); selection and control of UP function; configuring traffic steering at UPF 1148 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1144 over N2 to AN 1108; and determining SSC mode of a session. SM may refer to management of a PDU session, and a PDU session or “session” may refer to a PDU connectivity service that provides or enables the exchange of PDUs between the UE 1102 and the data network 1136.

The UPF 1148 may act as an anchor point for intra-RAT and inter-RAT mobility, an external PDU session point of interconnect to data network 1136, and a branching point to support multi-homed PDU session. The UPF 1148 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1148 may include an uplink classifier to support routing traffic flows to a data network.

The NSSF 1150 may select a set of network slice instances serving the UE 1102. The NSSF 1150 may also determine allowed NSSAI and the mapping to the subscribed S-NSSAIs, if needed. The NSSF 1150 may also determine the AMF set to be used to serve the UE 1102, or a list of candidate AMFs based on a suitable configuration and possibly by querying the NRF 1154. The selection of a set of network slice instances for the UE 1102 may be triggered by the AMF 1144 with which the UE 1102 is registered by interacting with the NSSF 1150, which may lead to a change of AMF. The NSSF 1150 may interact with the AMF 1144 via an N22 reference point; and may communicate with another NSSF in a visited network via an N31 reference point (not shown). Additionally, the NSSF 1150 may exhibit an Nnssf service-based interface.

The NEF 1152 may securely expose services and capabilities provided by 3GPP network functions for third party, internal exposure/re-exposure, AFs (e.g., AF 1160), edge computing or fog computing systems, etc. In such embodiments, the NEF 1152 may authenticate, authorize, or throttle the AFs. NEF 1152 may also translate information exchanged with the AF 1160 and information exchanged with internal network functions. For example, the NEF 1152 may translate between an AF-Service-Identifier and an internal 5GC information. NEF 1152 may also receive information from other NFs based on exposed capabilities of other NFs. This information may be stored at the NEF 1152 as structured data, or at a data storage NF using standardized interfaces. The stored information can then be re-exposed by the NEF 1152 to other NFs and AFs, or used for other purposes such as analytics. Additionally, the NEF 1152 may exhibit an Nnef service-based interface.

The NRF 1154 may support service discovery functions, receive NF discovery requests from NF instances, and provide the information of the discovered NF instances to the NF instances. NRF 1154 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1154 may exhibit the Nnrf service-based interface.

The PCF 1156 may provide policy rules to control plane functions to enforce them, and may also support unified policy framework to govern network behavior. The PCF 1156 may also implement a front end to access subscription information relevant for policy decisions in a UDR of the UDM 1158. In addition to communicating with functions over reference points as shown, the PCF 1156 exhibit an Npcf service-based interface.

The UDM 1158 may handle subscription-related information to support the network entities' handling of communication sessions, and may store subscription data of UE 1102. For example, subscription data may be communicated via an N8 reference point between the UDM 1158 and the AMF 1144. The UDM 1158 may include two parts, an application front end and a UDR. The UDR may store subscription data and policy data for the UDM 1158 and the PCF 1156, and/or structured data for exposure and application data (including PFDs for application detection, application request information for multiple UEs 1102) for the NEF 1152. The Nudr service-based interface may be exhibited by the UDR to allow the UDM 1158, PCF 1156, and NEF 1152 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1158 may exhibit the Nudm service-based interface.

The AF 1160 may provide application influence on traffic routing, provide access to NEF, and interact with the policy framework for policy control.

In some embodiments, the 5GC 1140 may enable edge computing by selecting operator/3^{rd} party services to be geographically close to a point that the UE 1102 is attached to the network. This may reduce latency and load on the network. To provide edge-computing implementations, the 5GC 1140 may select a UPF 1148 close to the UE 1102 and execute traffic steering from the UPF 1148 to data network 1136 via the N6 interface. This may be based on the UE subscription data, UE location, and information provided by the AF 1160. In this way, the AF 1160 may influence UPF (re)selection and traffic routing. Based on operator deployment, when AF 1160 is considered to be a trusted entity, the network operator may permit AF 1160 to interact directly with relevant NFs. Additionally, the AF 1160 may exhibit an Naf service-based interface.

The data network 1136 may represent various network operator services, Internet access, or third party services that may be provided by one or more servers including, for example, application/content server 1138.

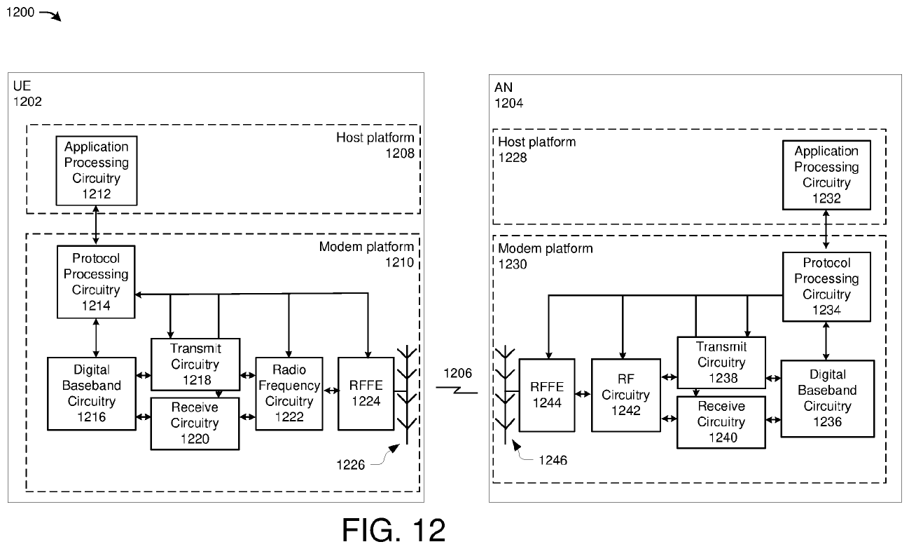

FIG. 12 schematically illustrates a wireless network 1200 in accordance with various embodiments. The wireless network 1200 may include a UE 1202 in wireless communication with an AN 1204. The UE 1202 and AN 1204 may be similar to, and substantially interchangeable with, like-named components described elsewhere herein.

The UE 1202 may be communicatively coupled with the AN 1204 via connection 1206. The connection 1206 is illustrated as an air interface to enable communicative coupling, and can be consistent with cellular communications protocols such as an LTE protocol or a 5G NR protocol operating at mmWave or sub-6 GHz frequencies.

The UE 1202 may include a host platform 1208 coupled with a modem platform 1210. The host platform 1208 may include application processing circuitry 1212, which may be coupled with protocol processing circuitry 1214 of the modem platform 1210. The application processing circuitry 1212 may run various applications for the UE 1202 that source/sink application data. The application processing circuitry 1212 may further implement one or more layer operations to transmit/receive application data to/from a data network. These layer operations may include transport (for example UDP) and Internet (for example, IP) operations

The protocol processing circuitry 1214 may implement one or more of layer operations to facilitate transmission or reception of data over the connection 1206. The layer operations implemented by the protocol processing circuitry 1214 may include, for example, MAC, RLC, PDCP, RRC and NAS operations.

The modem platform 1210 may further include digital baseband circuitry 1216 that may implement one or more layer operations that are “below” layer operations performed by the protocol processing circuitry 1214 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1210 may further include transmit circuitry 1218, receive circuitry 1220, RF circuitry 1222, and RF front end (RFFE) 1224, which may include or connect to one or more antenna panels 1226. Briefly, the transmit circuitry 1218 may include a digital-to-analog converter, mixer, intermediate frequency (IF) components, etc.; the receive circuitry 1220 may include an analog-to-digital converter, mixer, IF components, etc.; the RF circuitry 1222 may include a low-noise amplifier, a power amplifier, power tracking components, etc.; RFFE 1224 may include filters (for example, surface/bulk acoustic wave filters), switches, antenna tuners, beamforming components (for example, phase-array antenna components), etc. The selection and arrangement of the components of the transmit circuitry 1218, receive circuitry 1220, RF circuitry 1222, RFFE 1224, and antenna panels 1226 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1214 may include one or more instances of control circuitry (not shown) to provide control functions for the transmit/receive components.

A UE reception may be established by and via the antenna panels 1226, RFFE 1224, RF circuitry 1222, receive circuitry 1220, digital baseband circuitry 1216, and protocol processing circuitry 1214. In some embodiments, the antenna panels 1226 may receive a transmission from the AN 1204 by receive-beamforming signals received by a plurality of antennas/antenna elements of the one or more antenna panels 1226.

A UE transmission may be established by and via the protocol processing circuitry 1214, digital baseband circuitry 1216, transmit circuitry 1218, RF circuitry 1222, RFFE 1224, and antenna panels 1226. In some embodiments, the transmit components of the UE 1204 may apply a spatial filter to the data to be transmitted to form a transmit beam emitted by the antenna elements of the antenna panels 1226.

Similar to the UE 1202, the AN 1204 may include a host platform 1228 coupled with a modem platform 1230. The host platform 1228 may include application processing circuitry 1232 coupled with protocol processing circuitry 1234 of the modem platform 1230. The modem platform may further include digital baseband circuitry 1236, transmit circuitry 1238, receive circuitry 1240, RF circuitry 1242, RFFE circuitry 1244, and antenna panels 1246. The components of the AN 1204 may be similar to and substantially interchangeable with like-named components of the UE 1202. In addition to performing data transmission/reception as described above, the components of the AN 1208 may perform various logical functions that include, for example, RNC functions such as radio bearer management, uplink and downlink dynamic radio resource management, and data packet scheduling.

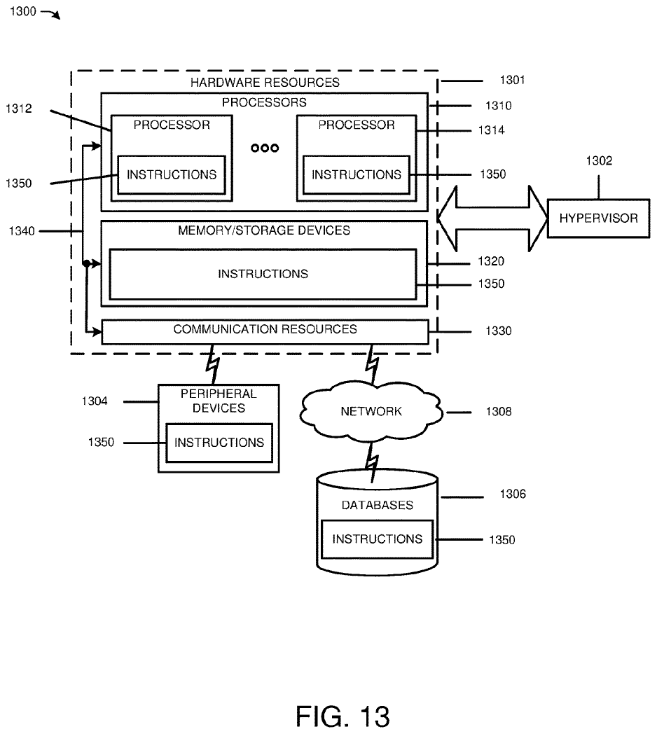

FIG. 13 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1300 including one or more processors (or processor cores) 1310, one or more memory/storage devices 1320, and one or more communication resources 1330, each of which may be communicatively coupled via a bus 1340 or other interface circuitry. For embodiments where node virtualization (e.g., NFV) is utilized, a hypervisor 1302 may be executed to provide an execution environment for one or more network slices/sub-slices to utilize the hardware resources 1300.

The processors 1310 may include, for example, a processor 1312 and a processor 1314. The processors 1310 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1320 may include main memory, disk storage, or any suitable combination thereof. The memory/storage devices 1320 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1330 may include interconnection or network interface controllers, components, or other suitable devices to communicate with one or more peripheral devices 1304 or one or more databases 1306 or other network elements via a network 1308. For example, the communication resources 1330 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1350 may comprise software, a program, an application, an applet, an app, or other executable code for causing at least any of the processors 1310 to perform any one or more of the methodologies discussed herein. The instructions 1350 may reside, completely or partially, within at least one of the processors 1310 (e.g., within the processor's cache memory), the memory/storage devices 1320, or any suitable combination thereof. Furthermore, any portion of the instructions 1350 may be transferred to the hardware resources 1300 from any combination of the peripheral devices 1304 or the databases 1306. Accordingly, the memory of processors 1310, the memory/storage devices 1320, the peripheral devices 1304, and the databases 1306 are examples of computer-readable and machine-readable media.

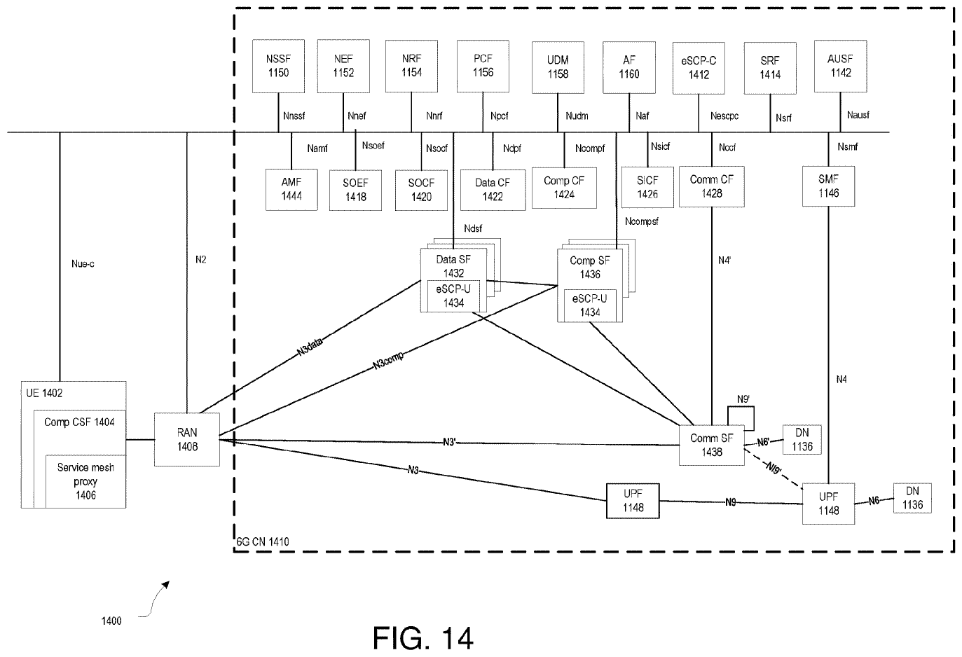

FIG. 14 illustrates a network, in accordance with one or more example embodiments of the present disclosure.

The network 1400 may operate in a matter consistent with 3GPP technical specifications or technical reports for 6G systems. In some examples, the network 1400 may operate concurrently with network 1100. For example, in some examples, the network 1400 may share one or more frequency or bandwidth resources with network 1100. As one specific example, a UE (e.g., UE 1402) may be configured to operate in both network 1400 and network 1100. Such configuration may be based on a UE including circuitry configured for communication with frequency and bandwidth resources of both networks 1100 and 1400. In general, several elements of network 1400 may share one or more characteristics with elements of network 1100. For the sake of brevity and clarity, such elements may not be repeated in the description of network 1400.

The network 1400 may include a UE 1402, which may include any mobile or non-mobile computing device designed to communicate with a RAN 1408 via an over-the-air connection. The UE 1402 may be similar to, for example, UE 1102. The UE 1402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 14, in some examples the network 1400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 14, the UE 1402 may be communicatively coupled with an AP such as AP 1106 as described with respect to FIG. 11. Additionally, although not specifically shown in FIG. 14, in some examples the RAN 1408 may include one or more ANs such as AN 1108 as described with respect to FIG. 11. The RAN 1408 and/or the AN of the RAN 1408 may be referred to as a base station (BS), a RAN node, or using some other term or name.

The UE 1402 and the RAN 1408 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1408 may allow for communication between the UE 1402 and a 6G core network (CN) 1410. Specifically, the RAN 1408 may facilitate the transmission and reception of data between the UE 1402 and the 6G CN 1410. The 6G CN 1410 may include various functions such as NSSF 1150, NEF 1152, NRF 1154, PCF 1156, UDM 1158, AF 1160, SMF 1146, and AUSF 1142. The 6G CN 1410 may additional include UPF 1148 and DN 1136 as shown in FIG. 14.

Additionally, the RAN 1408 may include various additional functions that are in addition to, or alternative to, functions of a legacy cellular network such as a 4G or 5G network. Two such functions may include a Compute Control Function (Comp CF) 1424 and a Compute Service Function (Comp SF) 1436. The Comp CF 1424 and the Comp SF 1436 may be parts or functions of the Computing Service Plane. Comp CF 1424 may be a control plane function that provides functionalities such as management of the Comp SF 1436, computing task context generation and management (e.g., create, read, modify, delete), interaction with the underlaying computing infrastructure for computing resource management, etc. Comp SF 1436 may be a user plane function that serves as the gateway to interface computing service users (such as UE 1402) and computing nodes behind a Comp SF instance. Some functionalities of the Comp SF 1436 may include: parse computing service data received from users to compute tasks executable by computing nodes; hold service mesh ingress gateway or service API gateway; service and charging policies enforcement; performance monitoring and telemetry collection, etc. In some examples, a Comp SF 1436 instance may serve as the user plane gateway for a cluster of computing nodes. A Comp CF 1424 instance may control one or more Comp SF 1436 instances.

Two other such functions may include a Communication Control Function (Comm CF) 1428 and a Communication Service Function (Comm SF) 1438, which may be parts of the Communication Service Plane. The Comm CF 1428 may be the control plane function for managing the Comm SF 1438, communication sessions creation/configuration/releasing, and managing communication session context. The Comm SF 1438 may be a user plane function for data transport. Comm CF 1428 and Comm SF 1438 may be considered as upgrades of SMF 1146 and UPF 1148, which were described with respect to a 5G system in FIG. 11. The upgrades provided by the Comm CF 1428 and the Comm SF 1438 may enable service-aware transport. For legacy (e.g., 4G or 5G) data transport, SMF 1146 and UPF 1148 may still be used.

Two other such functions may include a Data Control Function (Data CF) 1422 and Data Service Function (Data SF) 1432 may be parts of the Data Service Plane. Data CF 1422 may be a control plane function and provides functionalities such as Data SF 1432 management, Data service creation/configuration/releasing, Data service context management, etc. Data SF 1432 may be a user plane function and serve as the gateway between data service users (such as UE 1402 and the various functions of the 6G CN 1410) and data service endpoints behind the gateway. Specific functionalities may include: parse data service user data and forward to corresponding data service endpoints, generate charging data, report data service status.

Another such function may be the Service Orchestration and Chaining Function (SOCF) 1420, which may discover, orchestrate and chain up communication/computing/data services provided by functions in the network. Upon receiving service requests from users, SOCF 1420 may interact with one or more of Comp CF 1424, Comm CF 1428, and Data CF 1422 to identify Comp SF 1436, Comm SF 1438, and Data SF 1432 instances, configure service resources, and generate the service chain, which could contain multiple Comp SF 1436, Comm SF 1438, and Data SF 1432 instances and their associated computing endpoints.

Workload processing and data movement may then be conducted within the generated service chain. The SOCF 1420 may also responsible for maintaining, updating, and releasing a created service chain.

Another such function may be the service registration function (SRF) 1414, which may act as a registry for system services provided in the user plane such as services provided by service endpoints behind Comp SF 1436 and Data SF 1432 gateways and services provided by the UE 1402. The SRF 1414 may be considered a counterpart of NRF 1154, which may act as the registry for network functions.

Other such functions may include an evolved service communication proxy (eSCP) and service infrastructure control function (SICF) 1426, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1412 and eSCP-U 1434, for control plane service communication proxy and user plane service communication proxy, respectively. The SICF 1426 may control and configure eCSP instances in terms of service traffic routing policies, access rules, load balancing configurations, performance monitoring, etc.

Another such function is the AMF 1444. The AMF 1444 may be similar to 1144, but with additional functionality. Specifically, the AMF 1444 may include potential functional repartition, such as move the message forwarding functionality from the AMF 1444 to the RAN 1408.

Another such function is the service orchestration exposure function (SOEF) 1418. The SOEF may be configured to expose service orchestration and chaining services to external users such as applications.

The UE 1402 may include an additional function that is referred to as a computing client service function (comp CSF) 1404. The comp CSF 1404 may have both the control plane functionalities and user plane functionalities, and may interact with corresponding network side functions such as SOCF 1420, Comp CF 1424, Comp SF 1436, Data CF 1422, and/or Data SF 1432 for service discovery, request/response, compute task workload exchange, etc. The Comp CSF 1404 may also work with network side functions to decide on whether a computing task should be run on the UE 1402, the RAN 1408, and/or an element of the 6G CN 1410.

The UE 1402 and/or the Comp CSF 1404 may include a service mesh proxy 1406. The service mesh proxy 1406 may act as a proxy for service-to-service communication in the user plane. Capabilities of the service mesh proxy 1406 may include one or more of addressing, security, load balancing, and/or the like.

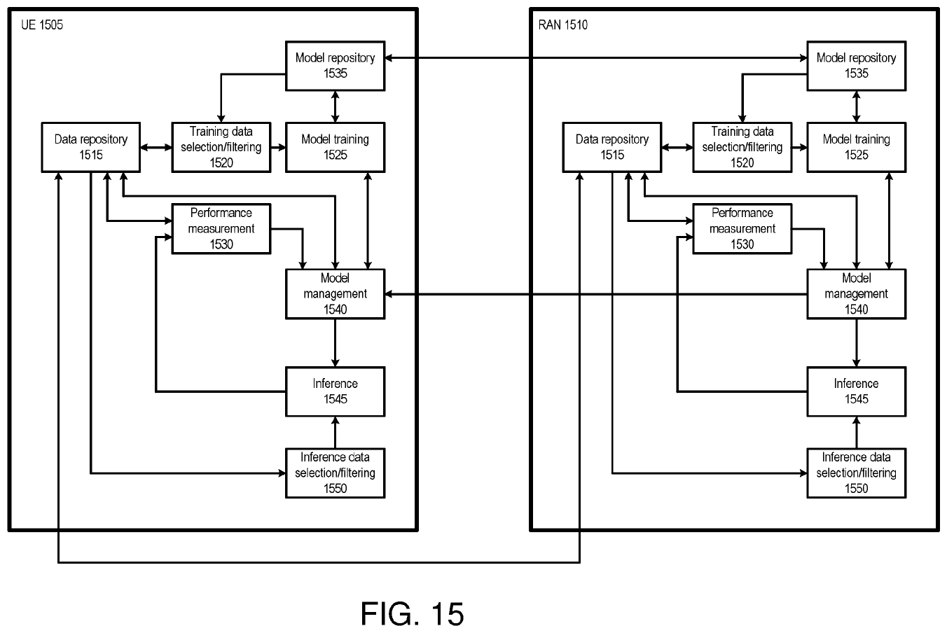

FIG. 15 illustrates a simplified block diagram of artificial (AI)-assisted communication between a user equipment and a radio access network, in accordance with one or more example embodiments of the present disclosure.

FIG. 15 depicts an example artificial (AI)-assisted communication architecture. More specifically, as described in further detail below, AI/machine learning (ML) models may be used or leveraged to facilitate over-the-air communication between UE 1505 and RAN 1510.

In this example, the UE 1505 and the RAN 1510 operate in a matter consistent with 3GPP technical specifications and/or technical reports for 6G systems. In some examples, the wireless cellular communication between the UE 1505 and the RAN 1510 may be part of, or operate concurrently with, networks zx00, yx00, and/or some other network described herein.

The UE 1505 may be similar to, and share one or more features with, ULE zx02, UE yx02, and/or some other UE described herein. The UE 1505 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 1510 may be similar to, and share one or more features with, RAN yx14, RAN zx08, and/or some other RAN described herein.

As may be seen in FIG. 15, the AI-related elements of UE 1505 may be similar to the AI-related elements of RAN 1510. For the sake of discussion herein, description of the various elements will be provided from the point of view of the UE 1505, however it will be understood that such discussion or description will apply to equally named/numbered elements of RAN 1510, unless explicitly stated otherwise.

As previously noted, the UE 1505 may include various elements or functions that are related to AI/ML. Such elements may be implemented as hardware, software, firmware, and/or some combination thereof. In examples, one or more of the elements may be implemented as part of the same hardware (e.g., chip or multi-processor chip), software (e.g., a computing program), or firmware as another element.

One such element may be a data repository 1515. The data repository 1515 may be responsible for data collection and storage. Specifically, the data repository 1515 may collect and store RAN configuration parameters, measurement data, performance key performance indicators (KPIs), model performance metrics, etc., for model training, update, and inference. More generally, collected data is stored into the repository. Stored data can be discovered and extracted by other elements from the data repository 1515. For example, as may be seen, the inference data selection/filter element 1550 may retrieve data from the data repository 1515. In various examples, the UE 1505 may be configured to discover and request data from the data repository 1510 in the RAN, and vice versa. More generally, the data repository 1515 of the UE 1505 may be communicatively coupled with the data repository 1515 of the RAN 1510 such that the respective data repositories of the UE and the RAN may share collected data with one another.

Another such element may be a training data selection/filtering functional block 1520. The training data selection/filter functional block 1520 may be configured to generate training, validation, and testing datasets for model training. Training data may be extracted from the data repository 1515. Data may be selected/filtered based on the specific AI/ML model to be trained. Data may optionally be transformed/augmented/pre-processed (e.g., normalized) before being loaded into datasets. The training data selection/filter functional block 1520 may label data in datasets for supervised learning. The produced datasets may then be fed into model training the model training functional block 1525.

As noted above, another such element may be the model training functional block 1525. This functional block may be responsible for training and updating(re-training) AI/ML models. The selected model may be trained using the fed-in datasets (including training, validation, testing) from the training data selection/filtering functional block. The model training functional block 1525 may produce trained and tested AI/ML models which are ready for deployment. The produced trained and tested models can be stored in a model repository 1535.

The model repository 1535 may be responsible for AI/ML models' (both trained and un-trained) storage and exposure. Trained/updated model(s) may be stored into the model repository 1535. Model and model parameters may be discovered and requested by other functional blocks (e.g., the training data selection/filter functional block 1520 and/or the model training functional block 1525). In some examples, the UE 1505 may discover and request AI/ML models from the model repository 1535 of the RAN 1510. Similarly, the RAN 1510 may be able to discover and/or request AI/ML models from the model repository 1535 of the UE 1505. In some examples, the RAN 1510 may configure models and/or model parameters in the model repository 1535 of the UE 1505.

Another such element may be a model management functional block 1540. The model management functional block 1540 may be responsible for management of the AI/MIL model produced by the model training functional block 1525. Such management functions may include deployment of a trained model, monitoring model performance, etc. In model deployment, the model management functional block 1540 may allocate and schedule hardware and/or software resources for inference, based on received trained and tested models. As used herein, “inference” refers to the process of using trained AI/ML model(s) to generate data analytics, actions, policies, etc. based on input inference data. In performance monitoring, based on wireless performance KPIs and model performance metrics, the model management functional block 1540 may decide to terminate the running model, start model re-training, select another model, etc. In examples, the model management functional block 1540 of the RAN 1510 may be able to configure model management policies in the UE 1505 as shown.

Another such element may be an inference data selection/filtering functional block 1550. The inference data selection/filter functional block 1550 may be responsible for generating datasets for model inference at the inference functional block 1545, as described below. Specifically, inference data may be extracted from the data repository 1515. The inference data selection/filter functional block 1550 may select and/or filter the data based on the deployed AI/MIL model. Data may be transformed/augmented/pre-processed following the same transformation/augmentation/pre-processing as those in training data selection/filtering as described with respect to functional block 1520. The produced inference dataset may be fed into the inference functional block 1545.

Another such element may be the inference functional block 1545. The inference functional block 1545 may be responsible for executing inference as described above. Specifically, the inference functional block 1545 may consume the inference dataset provided by the inference data selection/filtering functional block 1550, and generate one or more outcomes. Such outcomes may be or include data analytics, actions, policies, etc. The outcome(s) may be provided to the performance measurement functional block 1530.

The performance measurement functional block 1530 may be configured to measure model performance metrics (e.g., accuracy, model bias, run-time latency, etc.) of deployed and executing models based on the inference outcome(s) for monitoring purpose. Model performance data may be stored in the data repository 1515.

The following examples pertain to further embodiments.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Example 1 may include a user equipment (UE) device for low-power wake-up signaling, the UE device comprising processing circuitry coupled to storage for storing information associated with the low-power wake-up signaling, the processing circuitry configured to: detect, by a low-power wake-up receiver of the UE device, a first low-power wake-up signal; detect, by the low-power wake-up receiver, a second low-power wake-up signal; and signal, by the low-power wake-up receiver, based on the second low-power wake-up signal, to the main receiver, that the main receiver is to wake up from a sleep state.

Example 2 may include the UE device of example 1 and/or any other example herein, wherein the processing circuitry is further configured to detect a low-power wake-up signal burst comprising the first low-power wake-up signal, and wherein respective low-power wake-up signals in the low-power wake-up signal burst are associated with respective synchronization signal blocks (SSBs) in a SSB burst, wherein SSB burst is set of logically consecutive SSB transmissions that repeats every SSB transmission periodicity.

Example 3 may include the UE device of example 2 and/or any other example herein, wherein the first low-power wake-up signal is defined within a subframe, and wherein up to four low-power wake-up signals in the low-power wake-up signal burst are included in a half-frame, and UE device is configured to receive and process a subset of the four low-power wake-up signals.

Example 4 may include the UE device of example 2 and/or any other example herein, wherein the processing circuitry is further configured to detect two low-power wake-up signals, comprising the first low-power wake-up signal, defined within a subframe, and wherein up to eight low-power wake-up signals in the low-power wake-up signal burst are included in a half-frame, and UE device is configured to receive and process a subset of the eight low-power wake-up signals.

Example 5 may include the UE device of example 2 and/or any other example herein, wherein first low-power wake-up signals within a low-power wake-up signal burst comprise the first low-power wake-up signal and are associated with SSBs within a SSB burst in sequential order.

Example 6 may include the UE device of example 2 and/or any other example herein, wherein the processing circuitry is further configured to detect a set of low-power wake-up signals, comprising the first low-power wake-up signal, associated with one or more SSBs in a SSB burst.

Example 7 may include the UE device of example 1 or 2 and/or any other example herein, wherein the processing circuitry is further configured to detect a low-power wake-up signal burst comprising the first low-power wake-up signal, and wherein respective low-power wake-up signals in the low-power wake-up signal burst are associated with a Type0 common search space (CSS) set associated with synchronization signal blocks (SSBs) in a SSB burst.

Example 8 may include the UE device of example 7 and/or any other example herein, wherein the processing circuitry is further configured to determine timing of the first low-power wake-up signal based on timing parameters of the Type0 CSS set.

Example 9 may include the UE device of example 1 and/or any other example herein, wherein the processing circuitry is further configured to detect the first low-power wake-up signal based on a duty-cycle configuration of a low-power wake-up signal burst comprising the first low-power wake-up signal.

Example 10 may include the UE device of example 1 and/or any other example herein, wherein the processing circuitry is further configured to determine a Type0 CSS set based on a paging frame and a paging occasion for the UE device in a paging operation, and wherein the first low-power wake-up signal is associated with the Type0 CSS set.

Example 11 may include the UE device of example 1 and/or any other example herein, wherein the processing circuitry is further configured to wait for a time interval between the first low-power wake-up signal and a physical downlink control channel operation for a paging operation.

Example 12 may include a computer-readable storage medium comprising instructions to cause processing circuitry of a user equipment (UE) device for low-power wake-up signaling, upon execution of the instructions by the processing circuitry, to: detect, by a low-power wake-up receiver of the UE device, a first low-power wake-up signal; detect, by the low-power wake-up receiver, a second low-power wake-up signal; and signal, by the low-power wake-up receiver, based on the second low-power wake-up signal, to the main receiver, that the main receiver is to wake up from a sleep state.

Example 13 may include the computer-readable storage medium of example 12 and/or any other example herein, wherein execution of the instructions further causes the processing circuitry to detect a low-power wake-up signal burst comprising the first low-power wake-up signal, and wherein respective low-power wake-up signals in the low-power wake-up signal burst are associated with respective synchronization signal blocks (SSBs) in a SSB burst, wherein SSB burst is set of logically consecutive SSB transmissions that repeats every SSB transmission periodicity.

Example 14 may include the computer-readable storage medium of example 13 and/or any other example herein, wherein execution of the instructions further causes the processing circuitry to detect a set of low-power wake-up signals within a low-power wake-up signal burst, comprising the first low-power wake-up signal, associated with SSBs within a SSB burst in sequential order.

Example 15 may include the computer-readable storage medium of example 13 and/or any other example herein, wherein the first low-power wake-up signal is defined within a subframe, and wherein up to four low-power wake-up signals in the low-power wake-up signal burst are included in a half-frame.

Example 16 may include the computer-readable storage medium of example 13 and/or any other example herein, wherein execution of the instructions further causes the processing circuitry to detect two low-power wake-up signals, comprising the first low-power wake-up signal, defined within a subframe, and wherein up to eight low-power wake-up signals in the low-power wake-up signal burst are included in a half-frame.

Example 17 may include the computer-readable storage medium of example 12 and/or any other example herein, wherein execution of the instructions further causes the processing circuitry to detect a low-power wake-up signal burst comprising the first low-power wake-up signal, and wherein respective low-power wake-up signals in the low-power wake-up signal burst are associated with a Type0 common search space (CSS) set associated with synchronization signal blocks (SSBs) in a SSB burst.

Example 18 may include the computer-readable storage medium of example 17 and/or any other example herein, wherein execution of the instructions further causes the processing circuitry to determine timing of the first low-power wake-up signal based on timing parameters of the Type0 CSS set.

Example 19 may include the computer-readable storage medium of example 12 or 13 and/or any other example herein, wherein execution of the instructions further causes the processing circuitry to detect the first low-power wake-up signal based on a duty-cycle configuration of a low-power wake-up signal burst comprising the first low-power wake-up signal.

Example 20 may include the computer-readable storage medium of example 12 and/or any other example herein, wherein execution of the instructions further causes the processing circuitry to determine a Type0 CSS set based on a paging frame and a paging occasion for the UE device in a paging operation, and wherein the first low-power wake-up signal is associated with the Type0 CSS set.

Example 21 may include a method for low-power wake-up signaling, the method comprising: detecting, by low-power wake-up receiver processing circuitry of a user equipment (UE) device, a first low-power wake-up signal; detecting, by the low-power wake-up receiver processing circuitry, a second low-power wake-up signal; and signaling, by the low-power wake-up receiver processing circuitry, based on the second low-power wake-up signal, to the main receiver processing circuitry, that the main receiver is to wake up from a sleep state.

Example 22 may include the method of example 21 and/or any other example herein, further comprising detecting a low-power wake-up signal burst comprising the first low-power wake-up signal, and wherein respective low-power wake-up signals in the low-power wake-up signal burst are associated with respective synchronization signal blocks (SSBs) in a SSB burst.

Example 23 may include the method of example 22 and/or any other example herein, wherein the first low-power wake-up signal is defined within a subframe, and wherein up to four low-power wake-up signals in the low-power wake-up signal burst are included in a half-frame.

Example 24 may include an apparatus including means for: detecting, using low-power wake-up receiver processing circuitry of a user equipment (UE) device, a first low-power wake-up signal; detecting, using the low-power wake-up receiver processing circuitry, a second low-power wake-up signal; and signaling, using the low-power wake-up receiver processing circuitry, based on the second low-power wake-up signal, to the main receiver processing circuitry, that the main receiver is to wake up from a sleep state.

Example 25 may include a method of communicating in a wireless network as shown and described herein.

Example 26 may include a system for providing wireless communication as shown and described herein.

Example 27 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 1) may apply to the examples and embodiments discussed herein.

TABLE 1
Abbreviations

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACK | Acknowledgement |
| ACID | Application Client |
| | Identification |
| AF | Application Function |
| AM | Acknowledged Mode |
| AMBR | Aggregate Maximum Bit |
| | Rate |
| AMF | Access and Mobility |
| | Management Function |
| AN | Access Network |
| ANR | Automatic Neighbour |
| | Relation |
| AP | Application Protocol, |
| | Antenna Port, Access Point |
| API | Application Programming |
| | Interface |
| APN | Access Point Name |
| ARP | Allocation and Retention |
| | Priority |
| ARQ | Automatic Repeat Request |
| AS | Access Stratum |
| ASP | Application Service |
| | Provider |
| ASN.1 | Abstract Syntax Notation |
| | One |
| AUSF | Authentication Server |
| | Function |
| AWGN | Additive White Gaussian |
| | Noise |
| BAP | Backhaul Adaptation |
| | Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access |
| | Server |
| BSS | Business Support System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based Random |
| | Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple |
| | Access |
| CFRA | Contention Free Random |
| | Access |
| CG | Cell Group |
| CGF | Charging Gateway Function |
| CHF | Charging Function |
| CI | Cell Identity |
| CID | Cell-ID (e.g., positioning |
| | method) |
| CIM | Common Information |
| | Model |
| CIR | Carrier to Interference |
| | Ratio |
| CK | Cipher Key |
| CM | Connection Management, |
| | Conditional Mandatory |
| CMAS | Commercial Mobile Alert |
| | Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic |
| | Prefix, Connection Point |
| CPD | Connection Point |
| | Descriptor |
| CPE | Customer Premise |
| | Equipment |
| CPICH | Common Pilot Channel |
| CQI | Channel Quality Indicator |
| CPU | CSI processing unit, Central |
| | Processing Unit |
| C/R | Command/Response field |
| | bit |
| CRAN | Cloud Radio Access |
| | Network, Cloud RAN |
| CRB | Common Resource Block |
| CRC | Cyclic Redundancy Check |
| CRI | Channel-State Information |
| | Resource Indicator, CSI-RS |
| | Resource Indicator |
| C-RNTI | Cell RNTI |
| CS | Circuit Switched |
| CSAR | Cloud Service Archive |
| CSI | Channel-State Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise and |
| | interference ratio |
| CSMA | Carrier Sense Multiple |
| | Access |
| CSMA/CA | CSMA with collision |
| | avoidance |
| CSS | Common Search Space, |
| | Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct |
| | Current |
| DCI | Downlink Control |
| | Information |
| DF | Deployment Flavour |
| DL | Downlink |
| DMTF | Distributed Management |
| | Task Force |
| DPDK | Data Plane Development |
| | Kit |
| DM-RS, DMRS | Demodulation |
| | Reference Signal |
| DN | Data network |
| DNN | Data Network Name |
| DNAI | Data Network Access |
| | Identifier |
| DRB | Data Radio Bearer |
| DRS | Discovery Reference Signal |
| DRX | Discontinuous Reception |
| DSL | Domain Specific Language. |
| | Digital Subscriber Line |
| DSLAM | DSL Access Multiplexer |
| DwPTS | Downlink Pilot Time Slot |
| E-LAN | Ethernet Local Area |
| | Network |
| E2E | End-to-End |
| ECCA | extended clear channel |
| | assessment, extended CCA |
| ECCE | Enhanced Control Channel |
| | Element, Enhanced CCE |
| ED | Energy Detection |
| EDGE | Enhanced Datarates for |
| | GSM Evolution (GSM |
| | Evolution) |
| EAS | Edge Application Server |
| EASID | Edge Application Server |
| | Identification |
| ECS | Edge Configuration Server |
| ECSP | Edge Computing Service |
| | Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting Environment |
| EGMF | Exposure Governance |
| | tableManagement Function |
| EGPRS | Enhanced GPRS |
| EIR | Equipment Identity Register |
| eLAA | enhanced Licensed Assisted |
| | Access, enhanced |
| | LAA |
| EM | Element Manager |
| eMBB | Enhanced Mobile |
| | Broadband |
| EMS | Element Management |
| | System |
| eNB | evolved NodeB, E-UTRAN |
| | Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control Cannel |
| EPRE | Energy per resource |
| | element |
| EPS | Evolved Packet System |
| EREG | enhanced REG, enhanced |
| | resource element groups |
| ETSI | European |
| | Telecommunications |
| | Standards Institute |
| ETWS | Earthquake and Tsunami |
| | Warning System |
| eUICC | embedded UICC, |
| | embedded Universal |
| | Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access Channel |
| FAUSCH | Fast Uplink Signalling |
| | Channel |
| FB | Functional Block |
| FBI | Feedback Information |
| FCC | Federal Communications |
| | Commission |
| FCCH | Frequency Correction |
| | CHannel |
| FDD | Frequency Division Duplex |
| FDM | Frequency Division |
| | Multiplex |
| FDMA | Frequency Division |
| | Multiple Access |
| FE | Front End |
| FEC | Forward Error Correction |
| FFS | For Further Study |
| FFT | Fast Fourier Transformation |
| feLAA | further enhanced Licensed |
| | Assisted Access, further |
| | enhanced LAA |
| FN | Frame Number |
| FPGA | Field-Programmable Gate |
| | Array |
| FR | Frequency Range |
| FQDN | Fully Qualified Domain |
| | Name |
| G-RNTI | GERAN Radio Network |
| | Temporary Identity |
| GERAN | GSM EDGE RAN, GSM |
| | EDGE Radio Access |
| | Network |
| GGSN | Gateway GPRS Support |
| | Node |
| GLONASS | GLObal'naya |
| | NAvigatsionnaya |
| | Sputnikovaya Sistema |
| | (Engl.: Global Navigation |
| | Satellite System) |
| gNB | Next Generation NodeB |
| gNB-CUg | NB-centralized unit, Next |
| | Generation NodeB |
| | centralized unit |
| gNB-DUg | NB-distributed unit, Next |
| | Generation NodeB |
| | distributed unit |
| GNSS | Global Navigation Satellite |
| | System |
| GPRS | General Packet Radio |
| | Service |
| GPSI | Generic Public Subscription |
| | Identifier |
| GSM | Global System for Mobile |
| | Communications, Groupe |
| | Spécial Mobile |
| GTP | GPRS Tunneling Protocol |
| GTP-U | GPRS Tunnelling Protocol |
| | for User Plane |
| GTS | Go To Sleep Signal (related |
| | to WUS) |
| GUMMEI | Globally Unique MME |
| | Identifier |
| GUTI | Globally Unique |
| | Temporary UE Identity |
| HARQ | Hybrid ARQ, Hybrid |
| | Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile |
| | Network |
| HSDPA | High Speed Downlink |
| | Packet Access |
| HSN | Hopping Sequence Number |
| HSPA | High Speed Packet Access |
| HSS | Home Subscriber Server |
| HSUPA | High Speed Uplink Packet |
| | Access |
| HTTP | Hyper Text Transfer |
| | Protocol |
| HTTPS | Hyper Text Transfer |
| | Protocol Secure (https is |
| | http/1.1 over SSL, i.e. port |
| | 443) |
| I-Block | Information Block |
| ICCID | Integrated Circuit Card |
| | Identification |
| IAB | Integrated Access and |
| | Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of Electrical |
| | and Electronics |
| | Engineers |
| IEI | Information Element |
| | Identifier |
| IEIDL | Information Element |
| | Identifier Data Length |
| IETF | Internet Engineering |
| | Task Force |
| IF | Infrastructure |
| IM | Interference |
| | Measurement, |
| | Intermodulation, IP |
| | Multimedia |
| IMC | IMS Credentials |
| IMEI | International Mobile |
| | Equipment Identity |
| IMGI | International mobile |
| | group identity |
| IMPI | IP Multimedia Private |
| | Identity |
| IMPU | IP Multimedia PUblic |
| | identity |
| IMS | IP Multimedia |
| | Subsystem |
| IMSI | International Mobile |
| | Subscriber Identity |
| IoT | Internet of Things |
| IP | Internet Protocol |
| Ipsec | IP Security, Internet |
| | Protocol Security |
| IP-CAN | IP-Connectivity Access |
| | Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration Reference |
| | Point |
| ISDN | Integrated Services |
| | Digital Network |
| ISIM | IM Services Identity |
| | Module |
| ISO | International |
| | Organisation for |
| | Standardisation |
| ISP | Internet Service |
| | Provider |
| IWF | Interworking-Function |
| I-WLAN | Interworking WLAN |
| | Constraint length of the |
| | convolutional code, USIM |
| | Individual key |
| kB | Kilobyte (1000 bytes) |
| kbps | kilo-bits per second |
| Kc | Ciphering key |
| Ki | Individual subscriber |
| | authentication key |
| KPI | Key Performance |
| | Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal |
| | received power |
| L2 | Layer 2 (data link layer) |
| L3 | Layer 3 (network layer) |
| LAA | Licensed Assisted |
| | Access |
| LAN | Local Area Network |
| LADN | Local Area Data |
| | Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, |
| | Low Layer |
| | Compatibility |
| LPLMN | Local PLMN |
| LPP | LTE Positioning |
| | Protocol |
| LSB | Least Significant Bit |
| LTE | Long Term Evolution |
| LWA | LTE-WLAN |
| | aggregation |
| LWIP | LTE/WLAN Radio |
| | Level Integration with |
| | IPsec Tunnel |
| LTE | Long Term Evolution |
| M2M | Machine-to-Machine |
| MAC | Medium Access Control |
| | (protocol layering |
| | context) |
| MAC | Message authentication |
| | code (security/encryption |
| | context) |
| MAC-A | MAC used for |
| | authentication and key |
| | agreement (TSG T WG3 |
| | context) |
| MAC-I | MAC used for data |
| | integrity of signalling |
| | messages (TSG T WG3 |
| | context) |
| MANO | Management and |
| | Orchestration |
| MBMS | Multimedia Broadcast |
| | and Multicast Service |
| MBSFN | Multimedia Broadcast |
| | multicast service Single |
| | Frequency Network |
| MCC | Mobile Country Code |
| MCG | Master Cell Group |
| MCOT | Maximum Channel |
| | Occupancy Time |
| MCS | Modulation and coding |
| | scheme |
| MDAF | Management Data |
| | Analytics Function |
| MDAS | Management Data |
| | Analytics Service |
| MDT | Minimization of Drive |
| | Tests |
| ME | Mobile Equipment |
| MeNB | master eNB |
| MER | Message Error Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input Multiple |
| | Output |
| MLC | Mobile Location Centre |
| MM | Mobility Management |
| MME | Mobility Management |
| | Entity |
| MN | Master Node |
| MNO | Mobile Network |
| | Operator |
| MO | Measurement Object, |
| | Mobile Originated |
| MPBCH | MTC Physical |
| | Broadcast CHannel |
| MPDCCH | MTC Physical |
| | Downlink Control |
| | CHannel |
| MPDSCH | MTC Physical |
| | Downlink Shared |
| | CHannel |
| MPRACH | MTC Physical Random |
| | Access CHannel |
| MPUSCH | MTC Physical Uplink |
| | Shared Channel |
| MPLS | MultiProtocol Label |
| | Switching |
| MS | Mobile Station |
| MSB | Most Significant Bit |
| MSC | Mobile Switching |
| | Centre |
| MSI | Minimum System |
| | Information, MCH |
| | Scheduling Information |
| MSID | Mobile Station Identifier |
| MSIN | Mobile Station |
| | Identification Number |
| MSISDN | Mobile Subscriber |
| | ISDN Number |
| MT | Mobile Terminated, |
| | Mobile Termination |
| MTC | Machine-Type |
| | Communications |
| mMTC | massive MTC, massive |
| | Machine-Type |
| | Communications |
| MU-MIMO | Multi User MIMO |
| MWUS | MTC wake-up signal, |
| | MTC WUS |
| NACK | Negative |
| | Acknowledgement |
| NAI | Network Access |
| | Identifier |
| NAS | Non-Access Stratum, |
| | Non-Access Stratum |
| | layer |
| NCT | Network Connectivity |
| | Topology |
| NC-JT | Non-Coherent Joint |
| | Transmission |
| NEC | Network Capability |
| | Exposure |
| NE-DC | NR-E-UTRA Dual |
| | Connectivity |
| NEF | Network Exposure |
| | Function |
| NF | Network Function |
| NFP | Network Forwarding |
| | Path |
| NFPD | Network Forwarding |
| | Path Descriptor |
| NFV | Network Functions |
| | Virtualization |
| NFVI | NFV Infrastructure |
| NFVO | NFV Orchestrator |
| NG | Next Generation, Next |
| | Gen |
| NGEN-DC | NG-RAN E-UTRA-NR |
| | Dual Connectivity |
| NM | Network Manager |
| NMS | Network Management |
| | System |
| N-PoP | Network Point of |
| | Presence |
| NMIB, N-MIB | Narrowband MIB |
| NPBCH | Narrowband Physical |
| | Broadcast CHannel |
| NPDCCH | Narrowband Physical |
| | Downlink Control |
| | CHannel |
| NPDSCH | Narrowband Physical |
| | Downlink Shared |
| | CHannel |
| NPRACH | Narrowband Physical |
| | Random Access |
| | CHannel |
| NPUSCH | Narrowband Physical |
| | Uplink Shared CHannel |
| NPSS | Narrowband Primary |
| | Synchronization Signal |
| NSSS | Narrowband Secondary |
| | Synchronization Signal |
| NR | New Radio, Neighbour |
| | Relation |
| NRF | NF Repository Function |
| NRS | Narrowband Reference |
| | Signal |
| NS | Network Service |
| NSA | Non-Standalone |
| | operation mode |
| NSD | Network Service |
| | Descriptor |
| NSR | Network Service Record |
| NSSAI | Network Slice Selection |
| | Assistance Information |
| S-NNSAI | Single-NSSAI |
| NSSF | Network Slice Selection |
| | Function |
| NW | Network |
| NWUS | Narrowband wake-up |
| | signal, Narrowband |
| | WUS |
| NZP | Non-Zero Power |
| O&M | Operation and |
| | Maintenance |
| ODU2 | Optical channel Data |
| | Unit - type 2 |
| OFDM | Orthogonal Frequency |
| | Division Multiplexing |
| OFDMA | Orthogonal Frequency |
| | Division Multiple |
| | Access |
| OOB | Out-of-band |
| OOS | Out of Sync |
| OPEX | OPerating EXpense |
| OSI | Other System |
| | Information |
| OSS | Operations Support |
| | System |
| OTA | over-the-air |
| PAPR | Peak-to-Average Power |
| | Ratio |
| PAR | Peak to Average Ratio |
| PBCH | Physical Broadcast |
| | Channel |
| PC | Power Control, Personal |
| | Computer |
| PCC | Primary Component |
| | Carrier, Primary CC |
| PCell | Primary Cell |
| PCI | Physical Cell ID, |
| | Physical Cell Identity |
| PCEF | Policy and Charging |
| | Enforcement Function |
| PCF | Policy Control Function |
| PCRF | Policy Control and |
| | Charging Rules Function |
| PDCP | Packet Data |
| | Convergence Protocol, |
| | Packet Data |
| | Convergence Protocol |
| | layer |
| PDCCH | Physical Downlink |
| | Control Channel |
| PDCP | Packet Data |
| | Convergence Protocol |
| PDN | Packet Data Network, |
| | Public Data Network |
| PDSCH | Physical Downlink |
| | Shared Channel |
| PDU | Protocol Data Unit |
| PEI | Permanent Equipment |
| | Identifiers |
| PFD | Packet Flow Description |
| P-GW | PDN Gateway |
| PHICH | Physical hybrid-ARQ |
| | indicator channel |
| PHY | Physical layer |
| PLMN | Public Land Mobile |
| | Network |
| PIN | Personal Identification |
| | Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block |
| | group |
| ProSe | Proximity Services, |
| | Proximity-Based |
| | Service |
| PRS | Positioning Reference |
| | Signal |
| PRR | Packet Reception Radio |
| PS | Packet Services |
| PSBCH | Physical Sidelink |
| | Broadcast Channel |
| PSDCH | Physical Sidelink |
| | Downlink Channel |
| PSCCH | Physical Sidelink |
| | Control Channel |
| PSSCH | Physical Sidelink |
| | Shared Channel |
| PSCell | Primary SCell |
| PSS | Primary |
| | Synchronization Signal |
| PSTN | Public Switched |
| | Telephone Network |
| PT-RS | Phase-tracking reference |
| | signal |
| PTT | Push-to-Talk |
| PUCCH | Physical Uplink Control |
| | Channel |
| PUSCH | Physical Uplink Shared |
| | Channel |
| QAM | Quadrature Amplitude |
| | Modulation |
| QCI | QoS class of identifier |
| QCL | Quasi co-location |
| QFI | QoS Flow ID, QoS Flow |
| | Identifier |
| QoS | Quality of Service |
| QPSK | Quadrature (Quaternary) |
| | Phase Shift Keying |
| QZSS | Quasi-Zenith Satellite |
| | System |
| RA-RNTI | Random Access RNTI |
| RAB | Radio Access Bearer, |
| | Random Access Burst |
| RACH | Random Access Channel |
| RADIUS | Remote Authentication |
| | Dial In User Service |
| RAN | Radio Access Network |
| RAND | RANDom number (used |
| | for authentication) |
| RAR | Random Access Response |
| RAT | Radio Access |
| | Technology |
| RAU | Routing Area Update |
| RB | Resource block, Radio |
| | Bearer |
| RBG | Resource block group |
| REG | Resource Element |
| | Group |
| Rel | Release |
| REQ | REQuest |
| RF | Radio Frequency |
| RI | Rank Indicator |
| RIV | Resource indicator value |
| RL | Radio Link |
| RLC | Radio Link Control, |
| | Radio Link Control |
| | layer |
| RLC | AM RLC Acknowledged |
| | Mode |
| RLC UM | RLC Unacknowledged |
| | Mode |
| RLF | Radio Link Failure |
| RLM | Radio Link Monitoring |
| RLM-RS | Reference Signal for |
| | RLM |
| RM | Registration |
| | Management |
| RMC | Reference Measurement |
| | Channel |
| RMSI | Remaining MSI, |
| | Remaining Minimum |
| | System Information |
| RN | Relay Node |
| RNC | Radio Network |
| | Controller |
| RNL | Radio Network Layer |
| RNTI | Radio Network |
| | Temporary Identifier |
| ROHC | RObust Header |
| | Compression |
| RRC | Radio Resource Control, |
| | Radio Resource Control |
| | layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal Time |
| | difference |
| RTP | Real Time Protocol |
| RTS | Ready-To-Send |
| RTT | Round Trip Time |
| Rx | Reception, Receiving, |
| | Receiver |
| S1AP | S1 Application Protocol |
| S1-MME | S1 for the control plane |
| S1-U | S1 for the user plane |
| S-GW | Serving Gateway |
| S-RNTI | SRNC Radio Network |
| | Temporary Identity |
| S-TMSI | SAE Temporary Mobile |
| | Station Identifier |
| SA | Standalone operation |
| | mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary Component |
| | Carrier, Secondary CC |
| SCell | Secondary Cell |
| SCEF | Service Capability |
| | Exposure Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data Adaptation |
| | Protocol, Service Data |
| | Adaptation Protocol |
| | layer |
| SDL | Supplementary |
| | Downlink |
| SDNF | Structured Data Storage |
| | Network Function |
| SDP | Session Description |
| | Protocol |
| SDSF | Structured Data Storage |
| | Function |
| SDU | Service Data Unit |
| SEAF | Security Anchor |
| | Function |
| SeNB | secondary eNB |
| SEPP | Security Edge Protection |
| | Proxy |
| SFI | Slot format indication |
| SFTD | Space-Frequency Time |
| | Diversity, SFN and |
| | frame timing difference |
| SFN | System Frame Number |
| SgNB | Secondary gNB |
| SGSN | Serving GPRS Support |
| | Node |
| S-GW | Serving Gateway |
| SI | System Information |
| SI-RNTI | System Information |
| | RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session Management |
| | Function |
| SMS | Short Message Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent CSI |
| | RNTI |
| SPS | Semi-Persistent |
| | Scheduling |
| SQN | Sequence number |
| SR | Scheduling Request |
| SRB | Signalling Radio Bearer |
| SRS | Sounding Reference |
| | Signal |
| SS | Synchronization Signal |
| SSB | Synchronization Signal |
| | Block |
| SSID | Service Set Identifier |
| SS/PBCH | Block |
| SSBRI | SS/PBCH Block |
| | Resource Indicator, |
| | Synchronization Signal |
| | Block Resource |
| | Indicator |
| SSC | Session and Service |
| | Continuity |
| SS-RSRP | Synchronization Signal |
| | based Reference Signal |
| | Received Power |
| SS-RSRQ | Synchronization Signal |
| | based Reference Signal |
| | Received Quality |
| SS-SINR | Synchronization Signal |
| | based Signal to Noise |
| | and Interference Ratio |
| SSS | Secondary |
| | Synchronization Signal |
| SSSG | Search Space Set Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division Duplex |
| TDM | Time Division |
| | Multiplexing |
| TDMA | Time Division Multiple |
| | Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network |
| | Layer |
| TPC | Transmit Power Control |
| TPMI | Transmitted Precoding |
| | Matrix Indicator |
| TR | Technical Report |
| TRP, TRxP | Transmission |
| | Reception Point |
| TRS | Tracking Reference |
| | Signal |
| TRx | Transceiver |
| TS | Technical |
| | Specifications, |
| | Technical Standard |
| TTI | Transmission Time |
| | Interval |
| Tx | Transmission, |
| | Transmitting, |
| | Transmitter |
| U-RNTI | UTRAN Radio Network |
| | Temporary Identity |
| UART | Universal Asynchronous |
| | Receiver and |
| | Transmitter |
| UCI | Uplink Control |
| | Information |
| UE | User Equipment |
| UDM | Unified Data |
| | Management |
| UDP | User Datagram Protocol |
| UDSF | Unstructured Data |
| | Storage Network |
| | Function |
| UICC | Universal Integrated |
| | Circuit Card |
| UL | Uplink |
| UM | Unacknowledged Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra-Reliable and Low |
| | Latency |
| USB | Universal Serial Bus |
| USIM | Universal Subscriber |
| | Identity Module |
| USS | UE-specific search space |
| UTRA | UMTS Terrestrial Radio |
| | Access |
| UTRAN | Universal Terrestrial |
| | Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized |
| | Infrastructure Manager |
| VL | Virtual Link, |
| VLAN | Virtual LAN, Virtual |
| | Local Area Network |
| VM | Virtual Machine |
| VNF | Virtualized Network |
| | Function |
| VNFFG | VNF Forwarding Graph |
| VNFFGD | VNF Forwarding Graph |
| | Descriptor |
| VNFM | VNF Manager |
| VoIP | Voice-over-IP, Voice- |
| | over-Internet Protocol |
| VPLMN | Visited Public Land |
| | Mobile Network |
| VPN | Virtual Private Network |
| VRB | Virtual Resource Block |
| WiMAX | Worldwide |
| | Interoperability for |
| | Microwave Access |
| WLAN | Wireless Local Area |
| | Network |
| WMAN | Wireless Metropolitan |
| | Area Network |
| WPAN | Wireless Personal Area |
| | Network |
| X2-C | X2-Control plane |
| X2-U | X2-User plane |
| XML | eXtensible Markup |
| | Language |
| XRES | EXpected user |
| | RESponse |
| XOR | exclusive OR |
| ZC | Zadoff-Chu |
| ZP | Zero Po |

What is claimed is:

1. A user equipment (UE) device for low-power wake-up signaling, the UE device comprising processing circuitry coupled to storage for storing information associated with the low-power wake-up signaling, the processing circuitry configured to:
detect, by a low-power wake-up receiver of the UE device, a first low-power wake-up signal;
detect, by the low-power wake-up receiver, a second low-power wake-up signal; and
signal, by the low-power wake-up receiver, based on the second low-power wake-up signal, to the main receiver, that the main receiver is to wake up from a sleep state.

2. The UE device of claim 1, wherein the processing circuitry is further configured to detect a low-power wake-up signal burst comprising the first low-power wake-up signal, and wherein respective low-power wake-up signals in the low-power wake-up signal burst are associated with respective synchronization signal blocks (SSBs) in a SSB burst, wherein SSB burst is set of logically consecutive SSB transmissions that repeats every SSB transmission periodicity.

3. The UE device of claim 2, wherein the first low-power wake-up signal is defined within a subframe, and wherein up to four low-power wake-up signals in the low-power wake-up signal burst are included in a half-frame, and UE device is configured to receive and process a subset of the four low-power wake-up signals.

4. The UE device of claim 2, wherein the processing circuitry is further configured to detect two low-power wake-up signals, comprising the first low-power wake-up signal, defined within a subframe, and wherein up to eight low-power wake-up signals in the low-power wake-up signal burst are included in a half-frame, and UE device is configured to receive and process a subset of the eight low-power wake-up signals.

5. The UE device of claim 2, wherein first low-power wake-up signals within a low-power wake-up signal burst comprise the first low-power wake-up signal and are associated with SSBs within a SSB burst in sequential order.

6. The UE device of claim 2, wherein the processing circuitry is further configured to detect a set of low-power wake-up signals, comprising the first low-power wake-up signal, associated with one or more SSBs in a SSB burst.

7. The UE device of claim 1, wherein the processing circuitry is further configured to detect a low-power wake-up signal burst comprising the first low-power wake-up signal, and wherein respective low-power wake-up signals in the low-power wake-up signal burst are associated with a Type0 common search space (CSS) set associated with synchronization signal blocks (SSBs) in a SSB burst.

8. The UE device of claim 7, wherein the processing circuitry is further configured to determine timing of the first low-power wake-up signal based on timing parameters of the Type0 CSS set.

9. The UE device of claim 1, wherein the processing circuitry is further configured to detect the first low-power wake-up signal based on a duty-cycle configuration of a low-power wake-up signal burst comprising the first low-power wake-up signal.

10. The UE device of claim 1, wherein the processing circuitry is further configured to determine a Type0 CSS set based on a paging frame and a paging occasion for the UE device in a paging operation, and wherein the first low-power wake-up signal is associated with the Type0 CSS set.

11. The UE device of claim 1, wherein the processing circuitry is further configured to wait for a time interval between the first low-power wake-up signal and a physical downlink control channel operation for a paging operation.

12. A non-transitory computer-readable storage medium comprising instructions to cause processing circuitry of a user equipment (UE) device for low-power wake-up signaling, upon execution of the instructions by the processing circuitry, to:
detect, by a low-power wake-up receiver of the UE device, a first low-power wake-up signal;
detect, by the low-power wake-up receiver, a second low-power wake-up signal; and
signal, by the low-power wake-up receiver, based on the second low-power wake-up signal, to the main receiver, that the main receiver is to wake up from a sleep state.

13. The non-transitory computer-readable storage medium of claim 12, wherein execution of the instructions further causes the processing circuitry to detect a low-power wake-up signal burst comprising the first low-power wake-up signal, and wherein respective low-power wake-up signals in the low-power wake-up signal burst are associated with respective synchronization signal blocks (SSBs) in a SSB burst, wherein SSB burst is set of logically consecutive SSB transmissions that repeats every SSB transmission periodicity.

14. The non-transitory computer-readable storage medium of claim 13, wherein execution of the instructions further causes the processing circuitry to detect a set of low-power wake-up signals within a low-power wake-up signal burst, comprising the first low-power wake-up signal, associated with SSBs within a SSB burst in sequential order.

15. The non-transitory computer-readable storage medium of claim 13, wherein the first low-power wake-up signal is defined within a subframe, and wherein up to four low-power wake-up signals in the low-power wake-up signal burst are included in a half-frame.

16. The non-transitory computer-readable storage medium of claim 13, wherein execution of the instructions further causes the processing circuitry to detect two low-power wake-up signals, comprising the first low-power wake-up signal, defined within a subframe, and wherein up to eight low-power wake-up signals in the low-power wake-up signal burst are included in a half-frame.

17. The non-transitory computer-readable storage medium of claim 12, wherein execution of the instructions further causes the processing circuitry to detect a low-power wake-up signal burst comprising the first low-power wake-up signal, and wherein respective low-power wake-up signals in the low-power wake-up signal burst are associated with a Type0 common search space (CSS) set associated with synchronization signal blocks (SSBs) in a SSB burst.

18. The non-transitory computer-readable storage medium of claim 17, wherein execution of the instructions further causes the processing circuitry to determine timing of the first low-power wake-up signal based on timing parameters of the Type0 CSS set.

19. The non-transitory computer-readable storage medium of claim 12, wherein execution of the instructions further causes the processing circuitry to detect the first low-power wake-up signal based on a duty-cycle configuration of a low-power wake-up signal burst comprising the first low-power wake-up signal.

20. (canceled)

21. A method for low-power wake-up signaling, the method comprising:
detecting, by low-power wake-up receiver processing circuitry of a user equipment (UE) device, a first low-power wake-up signal;
detecting, by the low-power wake-up receiver processing circuitry, a second low-power wake-up signal; and
signaling, by the low-power wake-up receiver processing circuitry, based on the second low-power wake-up signal, to the main receiver processing circuitry, that the main receiver is to wake up from a sleep state.

22. (canceled)

23. (canceled)

24. (canceled)

25. (canceled)
